(19) United States
(12) Patent Application Publication
(10) Pub. No.: US 2018/0038388 A1
(43) Pub. Date: Feb. 8, 2018

(54) COMPRESSOR SYSTEM

(71) Applicant: MITSUBISHI HEAVY INDUSTRIES, LTD., Tokyo (JP)

(72) Inventor: Satoshi Mizukami, Tokyo (JP)

(73) Assignee: MITSUBISHI HEAVY INDUSTRIES, LTD., Tokyo (JP)

(21) Appl. No.: 15/555,022

(22) PCT Filed: Nov. 18, 2015
(86) PCT No.: PCT/JP2015/082395

§ 371 Date: Aug. 31, 2017

(30) Foreign Application Priority Data
Mar. 18, 2015 (JP) 2015-054570
Mar. 18, 2015 (JP) 2015-054983
Mar. 18, 2015 (JP) 2015-055098
Mar. 18, 2015 (JP) 2015-055099

(51) Int. Cl. F04D 29/58; F04D 25/08; H02K 7/14; F04D 29/64

(52) U.S. Cl. CPC F04D 29/5806; F04D 29/642; F04D 25/082; H02K 7/14; H02K 9/197

(57) ABSTRACT

A compressor system including a motor including: a rotor that rotates around an axis and a stator disposed on an outer circumferential side of the rotor with a gap from the rotor; a compressor that rotates together with the rotor to generate a compressed fluid; and a partitioning member that is disposed in the gap formed between the rotor and the stator to partition the gap in the radial direction, and forms a rotor-side flow passage through which a cooling fluid can flow along the axis with the rotor, and a stator-side flow passage through which the cooling fluid can flow along the axis with the stator. The partitioning member has a cylindrical shape with the axis as a center and has a shape in which a thickness dimension in a radial direction of the rotor increases from one side to the other side of the axis.

### TECHNICAL FIELD

The present invention relates to a compressor system.

Priority is claimed on Japanese Patent Application Nos. 2015-054570, 2015-055098, 2015-054983, and 2015-055099, filed Mar. 18, 2015, the contents of which are incorporated herein by reference.

### BACKGROUND ART

A compressor system in which a motor and a compressor are integrated has a compressor for compressing gases such as air and other gases, and a motor for driving the compressor. In the compressor system, a rotary shaft extending from a casing of the compressor is connected to a rotary shaft of a motor similarly extending from the casing of the motor, and the rotation of the motor is transmitted to the compressor. The rotary shafts of the motor and the compressor are supported by a plurality of bearings and stably rotate.

Such a compressor system is used in, for example, a subsea production system as in Non-Patent Literature 1 or a floating production storage and offloading (FPSO) unit as in Non-Patent Literature 2. When used in the subsea production system, the compressor system is installed on the seabed, and delivers production fluid mixed with crude oil and natural gas to the top of the sea surface from a production well drilled to the depth of several thousand meters from the seabed. Also, when used for floating type marine oil storage facilities, compressor systems are installed in marine facilities such as ships.

### CITATION LIST

[Non-Patent Literature 1]

Mitsubishi Heavy Industries Technical Review Vol. 34 No. 5 P310-P313
[Non-Patent Literature 2]

Turbomachinery International September/October 2014 P18-P24

Incidentally, in the motor of the compressor system, as the rotor rotates at a high speed, heat is generated between the rotor and the stator, and temperatures of the rotor and the stator rise. Since there is a possibility that the efficiency of the motor may be lowered or the lifetime of the motor may be shortened if the temperature of the rotor or the stator rises, it is necessary to cool the rotor and the stator.

However, in the case of cooling the rotor and the stator by circulating a cooling medium in the interior of the stator or in the gap between the stator and the rotor from one side to the other side in an axial direction of the rotor, the cooling medium warms during the circulation. Consequently, it is difficult to efficiently cool the rotor and the stator.

### SUMMARY OF INVENTION

One or more embodiments of the present invention provide a compressor system capable of efficiently cooling a motor.

A compressor system according to a first aspect of the present invention includes a motor which has a rotor configured to rotate around an axis, and a stator disposed on an outer circumferential side of the rotor with a gap from the rotor; a compressor which rotates together with the rotor to generate a compressed fluid; and a partitioning member which is disposed in the gap formed between the rotor and the stator to partition the gap in the radial direction, and forms a rotor-side flow passage through which a cooling fluid can flow along the axis with the rotor, and a stator-side flow passage through which the cooling fluid can flow along the axis with the stator, wherein the partitioning member has a surface in which a flow passage area decreases in a cross section orthogonal to the axis in at least one of the rotor-side flow passage and the stator-side flow passage in a direction in which the cooling fluid flows.

The temperature of the cooling fluid subjected to heat exchange with the rotor and the stator rises toward the downstream side in the flowing direction. Here, according to the compressor system of this aspect, by providing the partitioning member, the flow passage area becomes smaller in the flowing direction of the cooling fluid in at least one of the rotor-side flow passage and the stator-side flow passage. As a result, the flow velocity of the cooling fluid can be increased toward the downstream side, and the heat transfer coefficient can be improved. Therefore, even with the cooling fluid in which the temperature rises on the downstream side, sufficient heat exchange can be performed with the rotor and the stator. That is, it is possible to more uniformly cool the rotor and the stator over the direction of the axis by the cooling fluid.

In the compressor system according to the second aspect of the present invention, the cooling fluid flowing through the rotor-side flow passage and the stator-side flow passage in the first aspect may be a leaked flow of the compressed fluid from the compressor.

From the compressor, a leaked flow in which a part of the compressed fluid passes through the seal occurs. By positively using the leaked flow as a cooling fluid, it is not necessary to separately introduce the cooling fluid into the rotor-side flow passage and the stator-side flow passage. Therefore, since it is not necessary to newly provide a separate structure for introducing such a cooling fluid, which leads to cost reduction.

In the compressor system according to a third aspect of the present invention, the partitioning member in the first or second aspect may have a cylindrical shape with the axis as the center, and may have a shape in which an inner diameter dimension decreases from one side to the other side of the axis, and the cooling fluid may flow into the rotor-side flow passage from one side of the axis.

According to one or more embodiments, since the partitioning member has a cylindrical shape in which the inner diameter dimension decreases toward the other side in the direction of the axis, the cross-sectional area of the flow passage of the rotor-side flow passage can be made smaller in the flowing direction of the cooling fluid. Therefore, in the rotor-side flow passage, the flow velocity of the cooling fluid can be increased toward the downstream side, and the heat transfer coefficient can be improved. For this reason, heat exchange can be sufficiently performed even by a cooling medium in which the temperature rises on the downstream side, and the rotor can be cooled more uniformly over the direction of the axis.

Further, in the compressor system according to a fourth aspect of the present invention, the partitioning member in any one of the first to third aspects may have a cylindrical shape with the axis as the center, and may have a shape in which an outer diameter dimension decreases from one side to the other side of the axis, and the cooling fluid may flow into the stator-side flow passage from the other side of the axis.

According to one or more embodiments, by making the cooling fluid from the other side of the axis flow into the stator-side flow passage formed by the cylindrical partitioning member in which the outer diameter dimension decreases toward the other side in the direction of the axis, even in the stator-side flow passage, it is possible to reduce the cross-sectional area of the flow passage toward the downstream side. Therefore, the flow velocity of the cooling fluid can be increased toward the downstream side, and the heat transfer coefficient can be improved. Therefore, the stator can be more uniformly cooled throughout the direction of the axis.

In the compressor system according to a fifth aspect of the present invention, the partitioning member in the first or second aspect may have a cylindrical shape with the axis as the center, and may have a shape in which the thickness dimension in the radial direction of the rotor increases from one side to the other side of the axis, and the cooling fluid may flow into the rotor-side flow passage and the stator-side flow passage from one side of the axis.

According to one or more embodiments, since the partitioning member has a cylindrical shape in which the wall thickness dimension in the radial direction increases toward the other side in the direction of the axis, and the cooling fluid flows in from the one side in the direction of the axis, it is possible to reduce the cross-sectional area of the flow passage toward the downstream side in both of the rotor-side flow passage and the stator-side flow passage. Therefore, the flow velocity of the cooling fluid can be increased toward the downstream side in both of the rotor-side flow passage and the stator-side flow passage, and the heat transfer coefficient can be improved. Therefore, the rotor and the stator can be more uniformly cooled throughout the direction of the axis.

In the compressor system according to a sixth aspect of the present invention, the partitioning member according to any one of the first to fifth aspects may be provided at least in a region in which the rotor and the stator face in the radial direction of the rotor.

According to one or more embodiments, by providing the partitioning member in such a region, effective cooling can be performed by the cooling fluid in the facing region between the rotor and the stator having the largest calorific value.

A compressor system according to a seventh aspect of the present invention includes a motor which has a rotor configured to rotate around an axis, and a stator disposed on an outer circumferential side of the rotor with a gap allowing the cooling fluid to flow along the axis from the rotor; a compressor which rotates together with the rotor to generate a compressed fluid; and a turn imparting section which imparts a turning component directed forward in a rotational direction of the rotor to the cooling fluid which flows through the gap formed between the rotor and the stator.

According to one or more embodiments of such a compressor system, by imparting the turning component directed forward in the rotational direction with respect to the cooling fluid flowing through the gap between the rotor and the stator by the turn imparting unit, the flowing direction of the cooling fluid can be made to follow the advancing direction of the outer surface of the rotating rotor. Therefore, it is possible to suppress the amount of heat generated by shearing caused by rapid acceleration of the cooling fluid due to the contact between the cooling fluid and the outer surface of the rotor, and the cooling efficiency of the rotor can be improved.

In the compressor system according to an eighth aspect of the present invention, the turn imparting unit in the seventh aspect may be a partitioning member which is disposed in the gap between the rotor and the stator to partition the gap in the radial direction so that the cooling fluid can flow along the axis with the rotor, and in which a protrusion or a recess extending forward in the rotational direction of the rotor is formed on a surface facing the rotor toward a downstream side in the flowing direction of the cooling fluid.

According to one or more embodiments, by providing such a partitioning member, the cooling fluid flowing between the partitioning member and the rotor is guided by the protrusion or the recess. As a result, a turning component directed forward in the rotational direction toward the downstream side is imparted to the cooling fluid. Therefore, the flowing direction of the cooling fluid can be made to follow the advancing direction of the outer surface of the rotor, the amount of heat generated by shearing can be suppressed, and the cooling efficiency of the rotor can be improved.

In the compressor system according to the ninth aspect of the present invention, the recess may be formed in the partitioning member according to the eighth aspect, and a width dimension of the recess in the direction of the axis may be smaller on a downstream side than on an upstream side in the flowing direction of the cooling fluid.

According to one or more embodiments, by reducing the width dimension of the recess on the downstream side in this way, it is possible to increase the velocity component in the rotational direction (circumferential direction) on the downstream side. Therefore, the cooling fluid can be accelerated in the rotational direction on the downstream side, and the heat transfer on the downstream side can be improved. For this reason, it is possible to sufficiently cool the rotor even by the cooling air which has been heated up by performing heat exchange with the rotor on the upstream side, and the cooling efficiency of the rotor can be further improved.

In the compressor system according to a tenth aspect of the present invention, the turn imparting unit in the seventh aspect may be a guide member which is disposed on an upstream side in the flowing direction from an inflow port of the cooling fluid in the gap between the rotor and the stator, and is provided to be relatively non-rotatable with respect to the stator, and the guide member may have a guide surface which faces the upstream side in the flowing direction of the cooling fluid and inclines forward in the rotational direction of the rotor with respect to the axis, toward the downstream side.

According to one or more embodiments, by providing the guide member having such a guide surface, the cooling fluid can be guided by the guide surface. As a result, a turning component directed forward in the rotational direction toward the downstream side is imparted to the cooling fluid. Therefore, the flowing direction of the cooling fluid can be made to follow the advancing direction of the outer surface of the rotor, the amount of heat generated by shearing can be suppressed, and the cooling efficiency of the rotor can be improved.

In the compressor system according to an eleventh aspect of the present invention, a plurality of the guide members in the tenth aspect may be provided in a rotational direction of the rotor with a gap, and a gap dimension in the rotational direction between trailing edges of the guide members is smaller than the gap dimension in the rotational direction between leading edges of the guide members adjacent in the rotational direction.

According to one or more embodiments, the gap dimension between the trailing edges, which are the downstream end portions, is smaller than the gap dimension between the leading edges which are the upstream end portions of the guide member. Therefore, when the cooling fluid guided by the guide surface flows out from the space between the trailing edges of the guide members toward the gap formed between the rotor and the stator, the flow velocity increases as compared with the case of flowing into the space between the leading edges of the guide members. That is, the flow passage area of the cooling fluid can be reduced on the trailing edge side. Therefore, the cooling fluid can be accelerated forward in the rotational direction (circumferential direction), and the flowing direction of the cooling fluid can be made to follow the advancing direction of the outer surface of the rotor. Therefore, it is possible to suppress the amount of heat generated by shearing, and to improve the cooling efficiency of the rotor.

A compressor system according to a twelfth aspect of the present invention includes a motor which has a rotor configured to rotate around an axis, and a stator disposed on an outer circumferential side with a gap, which allows cooling fluid to flow along the axis side, from the rotor, a compressor which rotates together with the rotor to generate a compressed fluid; a plurality of partitioning members which are provided to be relatively non-rotatable with respect to the stator and to extend from the stator toward the rotor, and partition the gap formed between the stator and the rotor into a plurality of spaces in a circumferential direction; and a fluid introduction section which allows the cooling fluid to flow in at least two spaces among the plurality of spaces from different sides in the direction of the axis.

According to one or more embodiments of such a compressor system, the cooling air flows into each of a plurality of spaces formed by partitioning the gap between the rotor and the stator in the circumferential direction by the partitioning member, from different sides. Therefore, in these spaces, the cooling fluid flows in the mutually opposite directions of the axis. Since the cooling fluid flows, while heat exchange with the rotor is performed, the temperature of the cooling fluid on the downstream side in the flowing direction of the cooling fluid becomes higher than the temperature on the upstream side. However, since the flowing directions of the cooling fluid are the opposite directions between the plurality of spaces aligned in the circumferential direction and the rotor relatively rotates with respect to the plurality of spaces, for example, at the position (the position on the upstream side and the downstream side in a certain space) of the end portion in the direction of the axis of the partitioning member, the high-temperature cooling air and the low-temperature cooling air are alternately brought into contact with the rotor. Therefore, even if the cooling air reaches a high temperature at the position on the downstream side in a certain space, the high-temperature cooling air does not always come into contact with the same position of the rotor, and the rotor can be efficiently cooled over the direction of the axis.

Further, in the compressor system according to a thirteenth aspect of the present invention, the partitioning member in the twelfth aspect may have a plate shape, and may have a guide surface which faces the upstream side in the flowing direction of the cooling fluid and is inclined forward in the rotational direction of the rotor with respect to the axis, toward the downstream side

According to one or more embodiments, by guiding the cooling fluid with such a guide surface, the turning component directed forward in the rotational direction toward the downstream side is imparted to the cooling fluid. Therefore the flowing direction of the cooling fluid can be made to follow the advancing direction of the outer surface of the rotating rotor, and it is possible to suppress the amount of heat generated by shearing caused by rapid cooling of the cooling fluid due to the contact between the cooling fluid and the outer surface of the rotor. Therefore, the cooling efficiency of the rotor can be improved.

Further, in the compressor system according to a fourteenth aspect of the present invention, the partitioning member in the thirteenth aspect may be a member having a spiral plate shape which extends forward in the rotational direction of the rotor, toward the downstream side in the flowing direction of the cooling fluid, and the guide surface may be a surface which faces the upstream side in the flowing direction of the cooling fluid in the member having the spiral plate shape.

According to one or more embodiments, by using a member having a spiral plate shape as the partitioning member in this manner, a turning component directed forward in the rotational direction toward the downstream side can be effectively imparted to the cooling fluid. Since the cooling fluid comes into contact with the outer surface of the rotor, it is possible to suppress the amount of heat generated by shearing caused by rapid acceleration of the cooling fluid due to the contact between the cooling fluid and the outer surface of the rotor, and the cooling efficiency of the rotor can be improved.

In the compressor system according to a fifteenth aspect of the present invention, the partitioning member according to any one of the twelfth to fourteenth aspects may be provided at least in a region in which the rotor and the stator face in the radial direction of the rotor.

According to one or more embodiments, by providing the partitioning member in such a region, effective cooling can be performed by the cooling fluid in the facing region between the rotor and the stator having the largest calorific value.

A compressor system according to a sixteenth aspect of the present invention includes a motor which has a rotor configured to rotate around an axis, and a stator disposed on an outer circumferential side of the rotor with a gap from the rotor; a compressor which rotates together with the rotor to generate a compressed fluid; and a fluid supply member which is disposed in the gap formed between the rotor and the stator, is provided to be relatively non-rotatable with respect to the stator, extends in a direction of the axis of rotation of the rotor, and opens toward the rotor to form an ejection port capable of ejecting the cooling fluid.

According to one or more embodiments of such a compressor system, by separately providing a fluid supply member having an injection port for a cooling fluid formed therein, a low-temperature cooling fluid before heat exchange with the rotor can be supplied to the ejection port at all times. For this reason, it is possible to eject the low-temperature cooling fluid to the rotor from the ejection port at all times, thereby improving the cooling efficiency of the rotor.

In the compressor system according to a seventeenth aspect of the present invention, the ejection port in the fluid supply member in the sixteenth aspect may be formed so that the cooling fluid can be ejected toward the front side in the rotational direction of the rotor.

Since the rotor rotates, by ejecting the cooling fluid from the ejection port forward in the rotational direction of the rotor, the flowing direction of the cooling fluid can be made to follow the advancing direction of the outer surface of the rotating rotor. Therefore, it is possible to suppress the amount of heat generated by shearing caused by rapid acceleration of the cooling fluid due to the contact between the cooling fluid and the outer surface of the rotor. Therefore, the cooling efficiency of the rotor can be improved.

In the compressor system according to an eighteenth aspect of the present invention, in the fluid supply member according to the sixteenth or seventeenth aspect, a plurality of ejection ports may be formed at intervals in the direction of the axis, and a communication hole which extends in the direction of the axis and communicates with the plurality of ejection ports so that the cooling medium from the outside can flow in from one side of the axis may be formed.

According to one or more embodiments, by supplying the cooling fluid to the plurality of ejection ports aligned in the direction of the axis through the communication hole in this manner, the cooling fluid can be ejected to the outer surface of the rotor evenly throughout the direction of the axis. Therefore, the cooling efficiency of the rotor can be further improved.

Further, in the fluid supply member in the compressor system according to a nineteenth aspect of the present invention, the ejection port located on the downstream side in the flowing direction of the cooling fluid flowing through the communication hole in the eighteenth aspect may have an opening diameter larger than that of the ejection port located on the upstream side.

When the cooling fluid flows through the communication hole, the pressure loss increases toward the downstream side. Here, since the opening diameter of the ejection port on the downstream side is large, the cooling fluid having a sufficient flow rate can be ejected toward the rotor even on the downstream side. Therefore, the cooling efficiency of the rotor can be further improved.

Further, in the fluid supply member in the compressor system according to a twentieth aspect of the present invention, the plurality of the ejection ports of the fluid supply member in the eighteenth or nineteenth aspect may be formed at intervals in the direction of the axis and the circumferential direction of the rotor, and in the fluid supply member, more of the ejection ports located on the downstream side in the flowing direction of the cooling fluid flowing through the communication hole may be formed in the circumferential direction than the ejection ports located on the upstream side.

According to one or more embodiments, by increasing the number of ejection ports on the downstream side in this way, it is possible to eject the cooling fluid having a sufficient flow rate toward the rotor on the downstream side in which the pressure loss increases. Therefore, the cooling efficiency of the rotor can be further improved.

According to one or more embodiments of the compressor system, the motor can be efficiently cooled.

### BRIEF DESCRIPTION OF DRAWINGS

FIG. 1 is a schematic view illustrating a compressor system in a first embodiment of the present invention.

FIG. 2 is a schematic view illustrating a compressor system in a modified example of the first embodiment of the present invention.

FIG. 3 is a schematic view illustrating a compressor system in a second embodiment of the present invention.

FIG. 4 is a schematic view illustrating a compressor system in a third embodiment of the present invention.

FIG. 5 is an enlarged cross-sectional view including an axis illustrating a partitioning member in a compressor system in a third embodiment of the present invention.

FIG. 6 is a schematic view illustrating a main part of a compressor system in a modified example of the third embodiment of the present invention.

FIG. 7 is a schematic view illustrating a compressor system in a fourth embodiment of the present invention.

FIG. 8 is a schematic view illustrating a compressor system in a fourth embodiment of the present invention, and is a cross-sectional view taken along line A4-A4 of FIG. 7.

FIG. 9 is an enlarged exploded view of a guide member in a compressor system in a fourth embodiment of the present invention.

FIG. 10 is a schematic view illustrating a compressor system in a fifth embodiment of the present invention.

FIG. 11 is a cross-sectional view illustrating a main part of a compressor system of the fifth embodiment of the present invention and illustrating a cross-section taken along a line A5-A5 of FIG. 10.

FIG. 12 is a perspective view illustrating a fluid introduction section of the compressor system in the fifth embodiment of the present invention.

FIG. 13 is a cross-sectional view illustrating a main part of a compressor system according to a sixth embodiment of the present invention, taken along a cross-section corresponding to a cross-section taken along line A5-A5 of FIG. 10.

FIG. 14 is a cross-sectional view illustrating a main part of a modified example of a fifth embodiment and a sixth embodiment of the present invention, taken along a cross-section corresponding to the A5-A5 cross-section of FIG. 10.

FIG. 15 is a schematic view illustrating a compressor system of a seventh embodiment of the present invention.

FIG. 16 is a schematic view illustrating a compressor system in the seventh embodiment of the present invention and is a cross-sectional view taken along the line A7-A7 of FIG. 15.

FIG. 17 is a schematic view illustrating a main part of a compressor system in a first modified example of the seventh embodiment of the present invention.

FIG. 18 is a schematic view illustrating a main part of a compressor system in a second modified example of the seventh embodiment of the present invention.

FIG. 19 is a schematic view illustrating a main part of a compressor system in a third modified example of the seventh embodiment of the present invention.

FIG. 20 is a schematic view illustrating a compressor system according to a third modified example of the seventh embodiment of the present invention, and is a cross-sectional view taken along the line B7-B7 of FIG. 19.

FIG. 21 is a schematic view illustrating a compressor system in an eighth embodiment of the present invention, and is a cross-sectional view taken along a cross-section corresponding to a cross-section taken along the line A7-A7 of FIG. 15.

FIG. 22 is a schematic view illustrating a main part of a compressor system in a ninth embodiment of the present invention.

FIG. 23 is a schematic view illustrating a main part of a compressor system in a modified example of the ninth embodiment of the present invention.

### DETAILED DESCRIPTION OF EMBODIMENTS

### First Embodiment

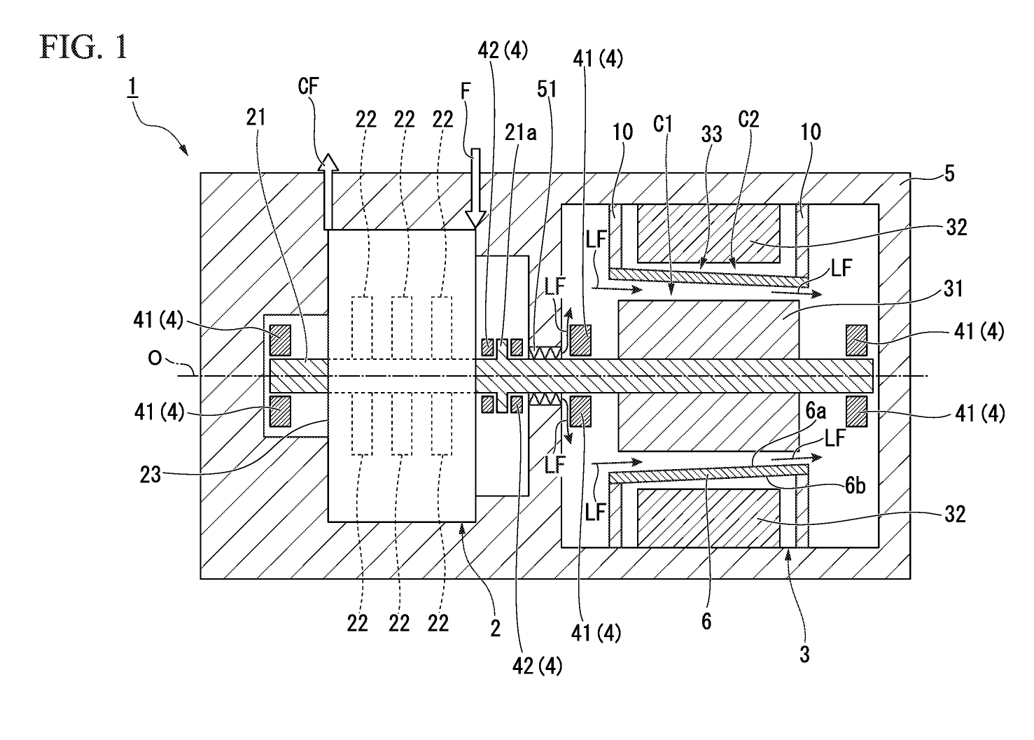

Hereinafter, a first embodiment of the present invention will be described with reference to FIG. 1.

A compressor system 1 is used in a subsea production system which is one of the development methods of a marine oil and gas field and is provided on the seabed, or is used in floating production storage and offloading (FPSO) and is provided on the sea surface. The compressor system 1 pumps a production fluid (hereinafter simply referred to as a fluid F) such as oil and gas collected from a production well of an oil and gas field present in the seabed from hundreds to thousands of meters.

The compressor system 1 includes a compressor 2 having a shaft 21 extending in the direction of the axis O (a left-right direction of FIG. 1), a motor 3 having a rotor 31 directly connected to the shaft 21, a bearing unit 4 which supports the shaft 21, a casing 5 which houses the motor 3 and the compressor 2, and a partitioning member 6 disposed on the outer circumferential side of the rotor 31.

The compressor 2 is housed in the casing 5 and compresses the fluid F by the rotation of the shaft 21 around the axis O together with the rotor 31 to generate the compressed fluid CF. The compressor 2 of the present embodiment has a shaft 21 extending in the direction of the axis O, an impeller 22 fixed to the shaft 21, and a housing 23 which houses the impeller 22.

The shaft 21 is a rotary shaft extending in the direction of the axis O and is supported by the casing 5 to be rotatable around the axis O. The shaft 21 penetrates the housing 23, and both ends thereof extend from the housing 23. The shaft 21 extends inside the casing 5 described later in the direction of the axis O.

The impeller 22 rotates together with the shaft 21 to compress the fluid F passing through the interior of the impeller 22 and generate a compressed fluid CF.

The housing 23 is an exterior component of the compressor 2 and houses the impeller 22 therein. The housing 23 is housed in the casing 5.

The motor 3 is housed in the casing 5 with a space in the direction of the axis O with respect to the compressor 2. The motor 3 has a rotor 31 fixed to be integrated with the shaft 21, and a stator 32 disposed on the outer circumferential side of the rotor 31.

The rotor 31 is rotatable around the axis O integrally with the shaft 21. The rotor 31 is directly fixed to the outer circumferential side of the shaft 21 to integrally rotate with respect to the shaft 21 of the compressor 2 without using a gear or the like. The rotor 31 has a rotor core (not illustrated) through which an induced current flows as the stator 32 generates a rotating magnetic field.

The stator 32 is provided with an annular gap 33 in the radial direction centered on the axis O with respect to the rotor 31 to cover the rotor 31 from the outer circumferential side. The stator 32 has a plurality of stator cores (not illustrated) disposed in the circumferential direction of the rotor 31, and a stator winding (not illustrated) wound around the stator core. The stator 32 rotates the rotor 31 by generating a rotating magnetic field when a current flows from the outside. The stator 32 is fixed to the casing 5 in the casing 5.

The bearing unit 4 is housed in the casing 5 to rotatably support the shaft 21. The bearing unit 4 of the present embodiment includes a plurality of journal bearings 41 and thrust bearings 42.

The journal bearing 41 supports the load acting on the shaft 21 in the radial direction. The journal bearing 41 is disposed at both ends of the shaft 21 in the direction of the axis O to sandwich the motor 3 and the compressor 2 from the direction of the axis O. The journal bearing 41 is also disposed between the region in which the compressor 2 is provided and the region in which the motor 3 is provided, and on the side closer to the motor 3 than the seal member 51 to be described later.

The thrust bearing 42 supports the load acting on the shaft 21 in the direction of the axis O via a thrust collar 21a formed on the shaft 21. The thrust bearing 42 is disposed between the region in which the compressor 2 is provided and the region in which the motor 3 is provided, and on the side closer to the compressor 2 than the seal member 51 to be described later.

The casing 5 houses the compressor 2 and the motor 3 therein. The casing 5 has a cylindrical shape along the axis O. The inner surface of the casing 5 protrudes toward the shaft 21 between the compressor 2 and the motor 3 in the direction of the axis O. A seal member 51, which seals a part between the region in which the compressor 2 is provided and the region in which the motor 3 is provided, is provided in the protruding portion.

The partitioning member 6 is disposed in the annular gap 33 between the rotor 31 and the stator 32, and is provided in a state in which it does not come into contact with the rotor 31 and the stator 32. Specifically, the partitioning member 6 has a cylindrical shape with the axis O as the center, and has a shape in which the outer diameter dimension and the inner diameter dimension gradually decrease from one side (the side close to the compressor 2) of the axis O toward the other side (the side away from the compressor 2).

In the present embodiment, the inner diameter dimension of the partitioning member 6 linearly decreases toward the other side of the axis O. That is, the inner surface (surface) 6a of the partitioning member 6 facing inward in the radial direction, is linearly inclined from one side of the axis O to the other side on a cross-section including the axis O. Further, the length dimension of the partitioning member 6 in the direction of the axis O is substantially the same as the length dimension in the direction of the axis O of the region in which the rotor 31 faces the stator 32 in the radial direction. The partitioning member 6 is provided in the facing region.

The thickness dimension of the partitioning member 6 is constant, and similarly, the outer diameter dimension of the partitioning member 6 decreases linearly toward the other side of the axis O. That is, the outer surface (surface) 6b of the partitioning member 6 facing outward in the radial direction is linearly inclined from one side of the axis O to the other side on the cross-section including the axis O.

Various materials such as metals, ceramics, and organic materials such as resins can be used as the partitioning member 6.

The partitioning member 6 is fixed to the casing 5 to be relatively non-rotatable with respect to the stator 32. For example, support members 10 which protrude inward in the radial direction to face each other in the direction of the axis O are provided in the casing 5 at both end surfaces facing in the direction of the axis O of the stator 32, and the partitioning member 6 is fixed to the radially inner side of the support members 10.

The support members 10 may have annular shapes with the axis O as the center or columnar shapes protruding radially inward at a part in the circumferential direction, and the shapes are not limited.

Further, the partitioning member 6 partitions the gap 33 in the radial direction and forms two spaces between the partitioning member 6 and the rotor 31. The two spaces are a rotor-side flow passage C1 between the partitioning member 6 and the rotor 31, and a stator-side flow passage C2 between the partitioning member 6 and the stator 32.

Here, in the compressor system 1 of the present embodiment, a part of the compressed fluid CF from the compressor 2 flows into the rotor-side flow passage C1 using the leaked flow LF leaking from the seal member 51 as a cooling fluid.

The leaked flow LF is caused to flow into the rotor-side flow passage C1 by, for example, a fluid introduction section (not illustrated). The fluid introduction section is, for example, a guide plate, a conduit, or the like provided in the casing 5 to guide the leaked flow LF flowing out of the seal member 51 to the motor 3 side.

In the aforementioned compressor system 1 of the present embodiment, the partitioning member 6 has an inner surface 6a in which a flow passage area in the cross-section orthogonal to the axis O in the rotor-side flow passage C1 gradually decreases in the direction in which the leaked flow LF flows along the rotor-side flow passage C1 along the axis O, that is, from one side toward the other side in the direction of the axis O.

Therefore, the temperature of the leaked flow LF subjected to heat exchange with the rotor 31 rises toward the downstream side in the flowing direction of the leaked flow LF. Here, in the compressor system 1 of the present embodiment, by providing the partitioning member 6, the cross-sectional area of the flow passage in the cross-section orthogonal to the axis O in the rotor-side flow passage C1 decreases in the flowing direction of the leaked flow LF. As a result, the flow velocity of the leaked flow LF can be increased toward the downstream side, and the heat transfer coefficient can be improved.

Therefore, even with the leaked flow LF having a higher temperature on the downstream side, it is possible to perform sufficient heat exchange with the rotor 31. That is, it is possible to more uniformly cool the rotor 31 over the direction of the axis O with the leaked flow LF. As a result, the motor 3 can be efficiently cooled.

Furthermore, when the leaked flow LF from the compressor 2 is actively used as a cooling fluid, it is not necessary to separately introduce the cooling fluid into the rotor-side flow passage C1. Therefore, there is no need to newly provide a structure which introduces such a cooling fluid, which leads to a reduction in cost.

Further, since the partitioning member 6 has a cylindrical shape in which the inner diameter dimension decreases toward the other side in the direction of the axis O, it is possible to easily form the rotor-side flow passage C1 so that the cross-sectional area of the flow passage decreases in the flowing direction of the leaked flow LF. Therefore, the flow velocity of the leaked flow LF can be increased toward the downstream side, and the heat transfer coefficient can be improved.

Furthermore, by providing the partitioning member 6 in the facing region between the rotor 31 and the stator 32, effective cooling can be performed by the leaked flow LF in the facing region in which the heat generation amount is the largest.

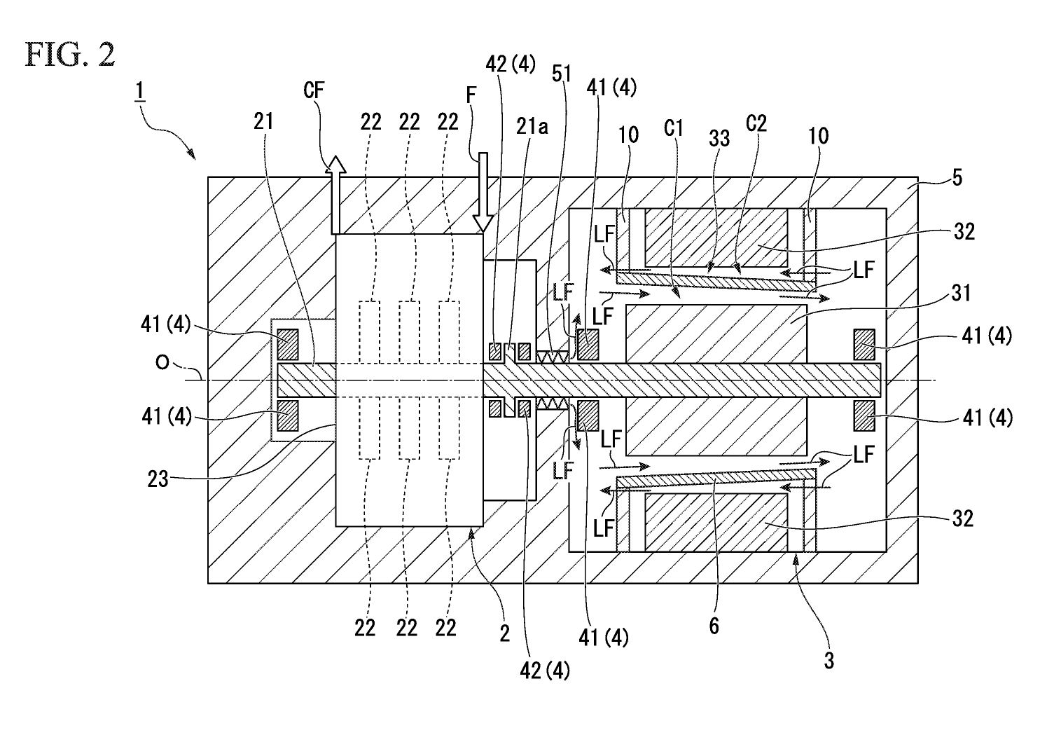

Here, in the present embodiment, as illustrated in FIG. 2, the leaked flow LF may flow into the stator-side flow passage C2 from the other side of the axis O. As the fluid introduction section, for example, an introduction flow passage or the like which is formed inside the casing 5 and is capable of guiding the leaked flow LF toward the other side in the direction of the axis O is used.

In the example illustrated in FIG. 2, a through-hole (not illustrated) penetrating in the direction of the axis O to open to the stator-side flow passage C2 is formed on the support member 10 so that the leaked flow LF can flow into the stator-side flow passage C2 and can flow out from the stator-side flow passage C2. Further, a columnar member provided in a part in the circumferential direction is used as the support member 10.

In this way, in the example illustrated in FIG. 2, the cylindrical partitioning member 6 having a smaller outer diameter dimension toward the other side in the direction of the axis O is provided, and the leaked flow LF is made to flow into the stator-side flow passage C2 from the other side of the axis O. Therefore, in addition to the rotor-side flow passage C1, the flow velocity of the leaked flow LF can also be increased toward the downstream side in the stator-side flow passage C2, and the heat transfer coefficient can be improved. Therefore, the stator 32 can be more uniformly cooled throughout the direction of the axis O.

Here, in the present embodiment, both of the inner diameter dimension and the outer diameter dimension of the partitioning member 6 are formed to become smaller toward the other side in the direction of the axis O. However, for example, at least one of the inner diameter dimension and the outer diameter dimension may be formed to become smaller toward the other side in the direction of the axis O.

### Second Embodiment

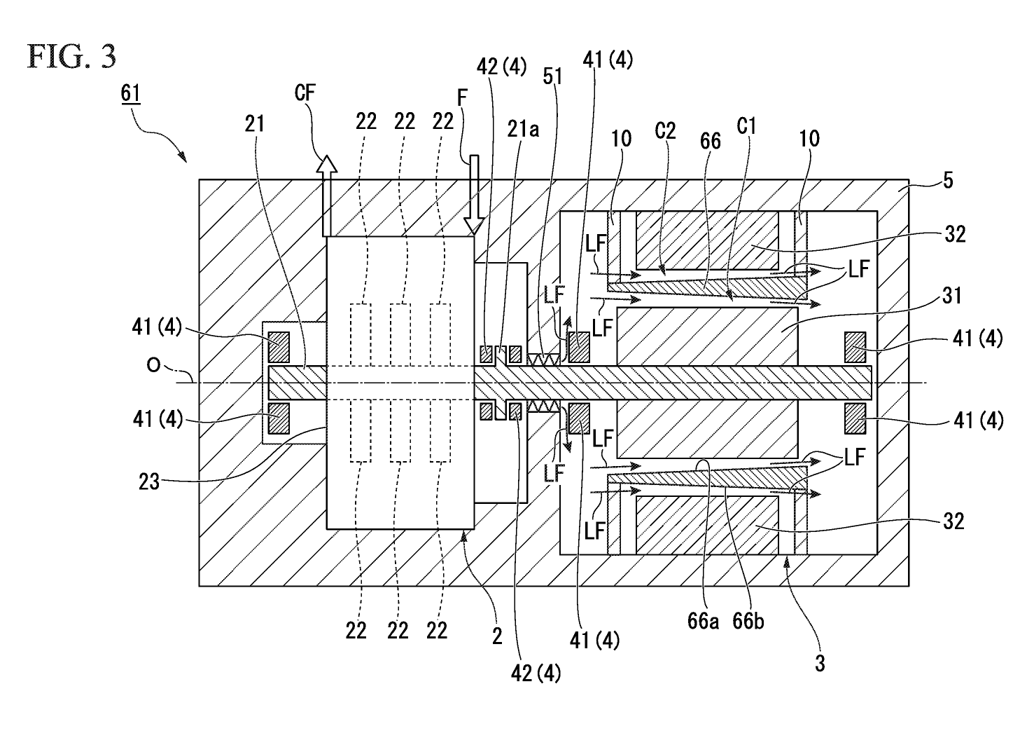

Next, a compressor system 61 of a second embodiment will be described with reference to FIG. 3.

In the second embodiment, the same constituent elements as those of the first embodiment are denoted by the same reference numerals, and a detailed description thereof will not be provided. In the compressor system 61 of the second embodiment, the shape of the partitioning member 66 is different from that of the first embodiment. Further, the leaked flow LF serving as a cooling fluid is caused to flow into both of the rotor-side flow passage C1 and the stator-side flow passage C2 from one side in the direction of the axis O.

The partitioning member 66 has a cylindrical shape with the axis O as a center and has a shape in which the wall thickness in the radial direction increases from one side of the axis O toward the other side. An inner surface 66a facing the radially inner side and an outer surface 66b facing the radially outer side in the partitioning member 66 are linearly inclined from one side of the axis O to the other side on a cross-section including the axis O.

In order to allow the leaked flow LF to flow into the stator-side flow passage C2 and to flow out of the stator-side flow passage C2, as in the case illustrated in FIG. 2, a through-hole (not illustrated) penetrating in the direction of the axis O is formed in the support member 10 to open to the stator-side flow passage C2. Further, a columnar member provided in a part in the circumferential direction is used as the support member 10.

According to the compressor system 61 of the present embodiment described above, since the partitioning member 66 has a cylindrical shape in which the wall thickness dimension in the radial direction increases toward the other side in the direction of the axis O, it is possible to easily form the rotor-side flow passage C1 and the stator-side flow passage C2 so that the cross-sectional area of the flow passage decreases toward the flowing direction of the leaked flow LF.

Therefore, the flow velocity of the leaked flow LF can be increased toward the downstream side, and the heat transfer coefficient can be improved. Therefore, heat exchange can be sufficiently performed even by the leaked flow LF having a high temperature on the downstream side, and the rotor 31 and the stator 32 can be more uniformly cooled over the direction of the axis O.

Although the first and second embodiments of the present invention have been described in detail with reference to the drawings, the respective configurations and combinations thereof in the respective embodiments are merely examples, and additions, omissions, substitutions, and other changes to the configuration can be made within the scope that does not depart from the gist of the present invention. Further, the present invention is not limited by the embodiments, and is limited only by the claims.

For example, the fluid introduction section is not necessarily provided. That is, the leaked flow LF from the seal member 51 may be made to naturally flow to one side in the direction of the axis O.

Also, the support member 10 is not limited to the aforementioned case. That is, the partitioning member 6 (66) may be held in the gap 33 between the rotor 31 and the stator 32.

Further, the leaked flow LF may flow only through the stator-side flow passage C2.

Further, in place of the leaked flow LF, a cooling medium introduced from the outside or bleed air from the compressor 2 may be used for the rotor-side flow passage C1 and the stator-side flow passage C2.

Further, the partitioning member 6 (66) is not limited to being provided only in the facing region between the rotor 31 and the stator 32, and the dimension in the direction of the axis O may be further decreased or may be increased.

Further, the inner surface 6a (66a) and the outer surface 6b (66b) of the partitioning member 6 (66) may be curvedly inclined in a cross-section including the axis O from one side of the axis O toward the other side, and a step or the like may be formed at an intermediate position in the direction of the axis O.

### Third Embodiment

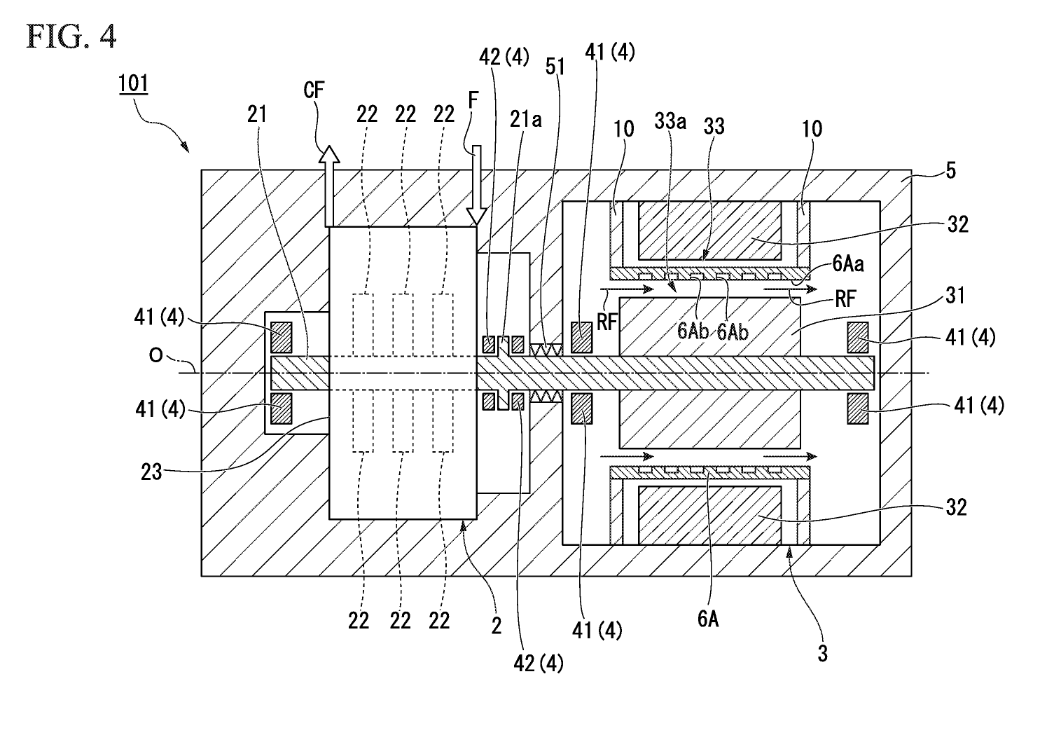

Hereinafter, a third embodiment of the present invention will be described with reference to FIG. 4.

A compressor system 101 includes a compressor 2 having a shaft 21 extending in the direction of the axis O (left-right direction in the drawing), a motor 3 having a rotor 31 directly connected to the shaft 21, a bearing unit 4 which supports the shaft 21, a casing 5 that houses the motor 3 and the compressor 2, and a partitioning member (turn imparting section) 6A disposed on the outer circumferential side of the rotor 31.

The partitioning member 6A is disposed in an annular gap 33 between the rotor 31 and the stator 32, and is provided in a state in which it does not come into contact with the rotor 31 and the stator 32. Specifically, the partitioning member 6A has a cylindrical shape with the axis O as the center.

Various materials such as metals, ceramics, and organic materials such as resins can be used for the partitioning member 6A.

The partitioning member 6A is fixed to the casing 5 to be relatively non-rotatable with respect to the stator 32. For example, support members 10 that protrude inward in the radial direction to face both end surfaces of the stator 32 directed to the direction of the axis O in the direction of the axis O are provided in the casing 5. The partitioning member 6A is fixed to the support members 10.

The support members 10 may have annular shapes with the axis O as the center or column shapes protruding radially inward in a part in the circumferential direction, and the shapes are not limited.

Further, a cooling fluid RF can flow through the gap 33a between the partitioning member 6A and the rotor 31. As the cooling fluid RF, it is possible to use, for example, a leaked flow in which a part of the compressed fluid CF from the compressor 2 has leaked from the seal member 51, a cooling medium introduced from the outside of the casing 5, bleed air from the compressor 2 or the like. The cooling fluid RF flows into the gap 33a from the compressor 2 side, which is one side in the direction of the axis O, due to a flow passage, a guide plate or the like (not illustrated) provided in the casing 5.

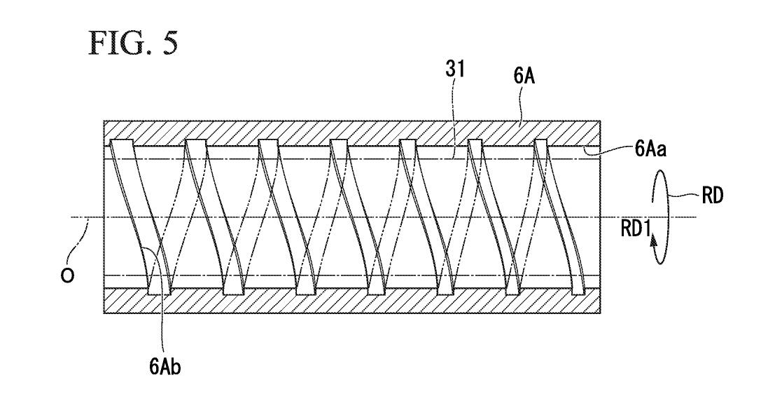

Further, as illustrated in FIG. 5, in the partitioning member 6A, a recess 6Ab which is recessed radially outward on the inner surface (surface) 6Aa facing the rotor 31 side, and has a spiral groove shape extending to the front RD1 of the rotor 31 in the rotational direction RD, toward the downstream side of the cooling fluid RF in the flowing direction.

According to the aforementioned compressor system 101 of the present embodiment, since the turning component directed toward the front RD1 in the rotational direction RD is imparted to the cooling fluid RF flowing between the rotor 31 and the stator 32 by the partitioning member 6A, the flowing direction of the cooling fluid RF can be made to follow the advancing direction of the outer surface of the rotating rotor 31. As a result, it is possible to suppress the amount of heat generated by shearing caused by rapid acceleration of the cooling fluid RF due to the contact between the cooling fluid RF and the outer surface of the rotor 31. Therefore, the cooling efficiency of the rotor 31 can be improved, and the motor can be efficiently cooled.

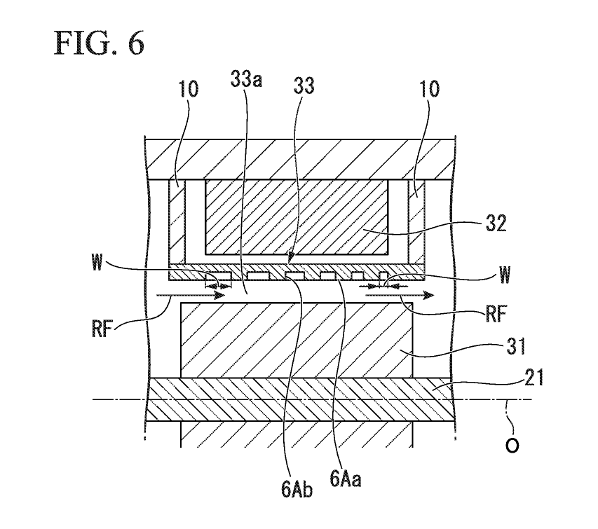

Here, in this embodiment, as illustrated in FIG. 6, the dimension of the width W in the direction of the axis O in the recess 6Ab may be smaller on the downstream side than on the upstream side. In this way, by narrowing the dimension of the width W of the recess 6Ab on the downstream side, it is possible to increase the velocity component in the rotational direction RD (circumferential direction) on the downstream side. Therefore, the cooling fluid RF can be accelerated on the downstream side, and the heat transfer on the downstream side can be improved. Therefore, it is also possible to sufficiently cool the rotor 31 on the downstream side with the cooling air RF in which the temperature has increased due to heat exchange with the rotor 31 on the upstream side.

In the present embodiment, the formation interval of the recess 6Ab in the direction of the axis O may be narrowed on the downstream side as compared with the upstream side. That is, on the downstream side, the recess 6Ab may extend to follow the rotational direction RD. In this way, since the formation interval of the recess 6Ab in the direction of the axis O is narrowed on the downstream side, the cooling fluid RF can be greatly accelerated in the rotational direction RD (circumferential direction) on the downstream side, and the heat transfer on the downstream side can be further improved.

Further, although the recess 6Ab is formed in the partitioning member 6A, instead of the recess 6Ab, a spiral protrusion protruding radially inward from the inner surface 6Aa may be formed.

Further, the partitioning member 6A is not limited to a cylindrical shape, and may be a member divided into a plurality of pieces in the circumferential direction. That is, the partitioning member 6A may be a member having an inner surface 6Aa that is curved along the outer surface of the rotor 31.

In addition, the recess 6Ab may not be continuous in the direction of the axis O and may be discontinuously formed.

### Fourth Embodiment

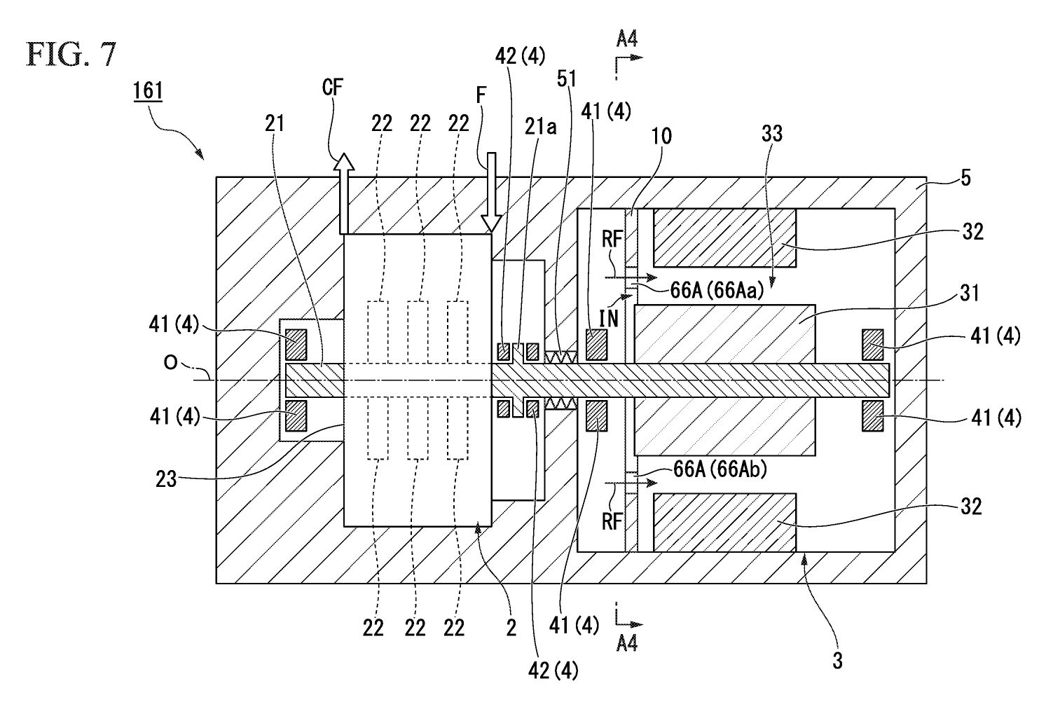

Next, a compressor system 161 of the fourth embodiment will be described with reference to FIGS. 7 to 9.

In the fourth embodiment, the same constituent elements as those of the third embodiment are denoted by the same reference numerals, and a detailed description thereof will not be provided. The compressor system 161 of the fourth embodiment is different from the compressor system 161 of the third embodiment in that a guide member (turn imparting portion) 66A is provided instead of the partitioning member 6A of the third embodiment.

As illustrated in FIG. 7, the guide member 66A is disposed to be closer to the upstream side in the flowing direction of the cooling fluid RF than the inflow port IN of the cooling fluid RF in the gap 33 between the rotor 31 and the stator 32 (on one side in the direction of the axis O). Here, the inflow port IN represents a region on the upstream side of the opening (inlet) on the upstream side of the gap 33.

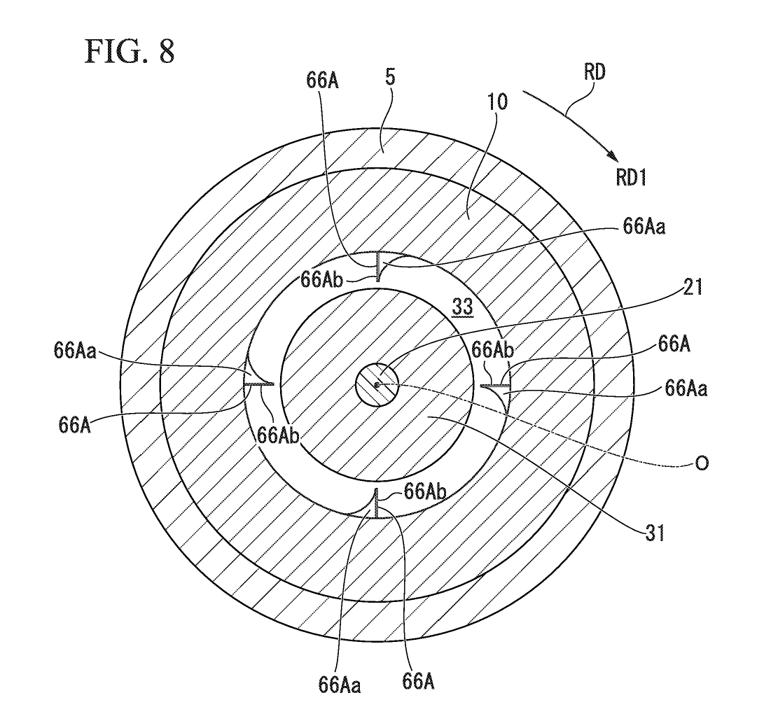

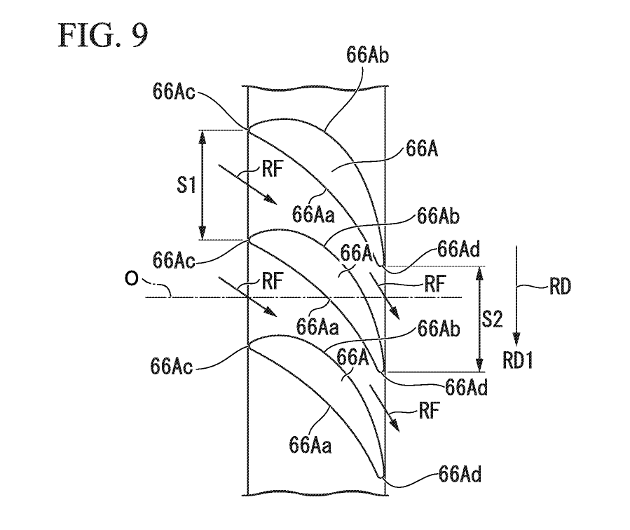

As illustrated in FIGS. 8 and 9, since a plurality of guide members 66A are fixed to the support member 10 to protrude inward in the radial direction from the support member 10 at an interval therebetween in the rotational direction RD, the plurality of guide members 66A are provided to be relatively non-rotatable with respect to the stator 32.

As illustrated in FIG. 9, each guide member 66A is formed to be curved toward the front RD1 in the rotational direction RD toward the downstream side in the flowing direction of the cooling fluid RF which is the other side in the direction of the axis O. Thus, the guide member 66A has a guide surface 66Aa that faces the upstream side and is curved and inclined toward the front RD1 in the rotational direction RD with respect to the axis O toward the downstream side, and a rear surface 66Ab which faces the downstream side and is curved and inclined toward the front RD1 in the rotational direction RD with respect to the axis O toward the downstream side. Among the guide members 66A adjacent to each other in the rotational direction RD, the guide surface 66Aa of one guide member 66A and the rear surface 66Ab of the other guide member 66A face each other in the rotational direction RD (circumferential direction).

Further, in the present embodiment, the guide member 66A is formed into a blade shape in a cross-section orthogonal to the radial direction with the guide surface 66Aa and the rear surface 66Ab.

Here, an upstream end portion of the guide member 66A is set as a leading edge 66Ac, and a downstream end portion is set as a trailing edge 66Ad. In the present embodiment, the dimension of the gap S2 in the rotational direction RD (circumferential direction) between the trailing edges 66Ad of the guide member 66A is smaller than the gap S1 in the rotational direction RD (circumferential direction) between the leading edges 66Ac of the guide member 66A adjacent to each other in the rotational direction RD.

According to the compressor system 161 of the present embodiment described above, by providing the guide member 66A having the guide surface 66Aa, it is possible to guide the cooling fluid RF by the guide surface 66Aa. As a result, a turning component directed to the front RD1 in the rotational direction RD toward the downstream side is imparted to the cooling fluid RF.

It is possible to make the flowing direction of the cooling fluid RF follow the advancing direction of the outer surface of the rotating rotor 31. Therefore, it is possible to suppress the amount of heat generated by shearing caused by rapid acceleration of the cooling fluid RF due to the contact of the cooling fluid RF with the outer surface of the rotor 31. As a result, the cooling efficiency of the rotor 31 can be improved, and the motor 3 can be efficiently cooled.

Further, the gap between the trailing edges 66Ad is smaller than the gap between the leading edges 66Ac of the guide member 66A. Therefore, when the cooling fluid RF guided by the guide surface 66Aa flows out from the space between the trailing edges 66Ad of the guide member 66A toward the gap 33 formed between the rotor 31 and the stator 32, the flow velocity can be enhanced compared to the case in which the flow cooling fluid RF flows into the space between the leading edges 66Ac of the member 66A.

That is, the flow passage area of the cooling fluid RF can be reduced on the trailing edge 66Ad side. Therefore, the cooling fluid RF can be accelerated in the rotational direction RD, the cooling fluid RF can be accelerated in the rotational direction RD on the downstream side, and the heat transfer on the downstream side can be improved. Therefore, it is possible to sufficiently cool the rotor 31 even at the downstream side with the cooling air RF increased in temperature by performing heat exchange with the rotor 31 on the upstream side, and the cooling efficiency of the rotor 31 can be further improved.

Here, in the present embodiment, a member having a blade shape in the cross-section is provided as the guide member 66A, but the present invention is not limited thereto. That is, the guide member 66A may have a simple flat plate shape having a rectangular cross-section. The guide surface 66Aa is not limited to being formed in a curved shape, but the guide surface 66Aa may have a planar shape that faces the upstream side and is inclined to the front side in the rotational direction RD with respect to the axis O toward the downstream side. The same also applies to the rear surface 66Ab.

The gap S1 between the leading edges 66Ac and the gap S2 between the trailing edges 66Ad may have the same dimensions.

Further, the guide member 66A is not limited to being provided at the inflow port IN, but may be disposed, for example, in the gap 33 between the rotor 31 and the stator 32. In this case, for example, a cylindrical member similar to the partitioning member 6A of the third embodiment may be provided, and the guide member 66A may be provided on the inner surface of the cylindrical member facing the rotor 31 side.

Although the third and fourth embodiments of the present invention have been described in detail with reference to the drawings, the respective configurations and combinations thereof in the respective embodiments are merely examples, and additions, omissions, substitutions, and other changes to the configuration can be made within the scope that does not depart from the gist of the present invention. Further, the present invention is not limited by the embodiments, and is limited only by the claims.

For example, the partitioning member 6A of the third embodiment and the guide member 66A of the fourth embodiment may be used in combination.

Further, the cooling fluid RF may be circulated between the stator 32 and the partitioning member 6A.

### Fifth Embodiment

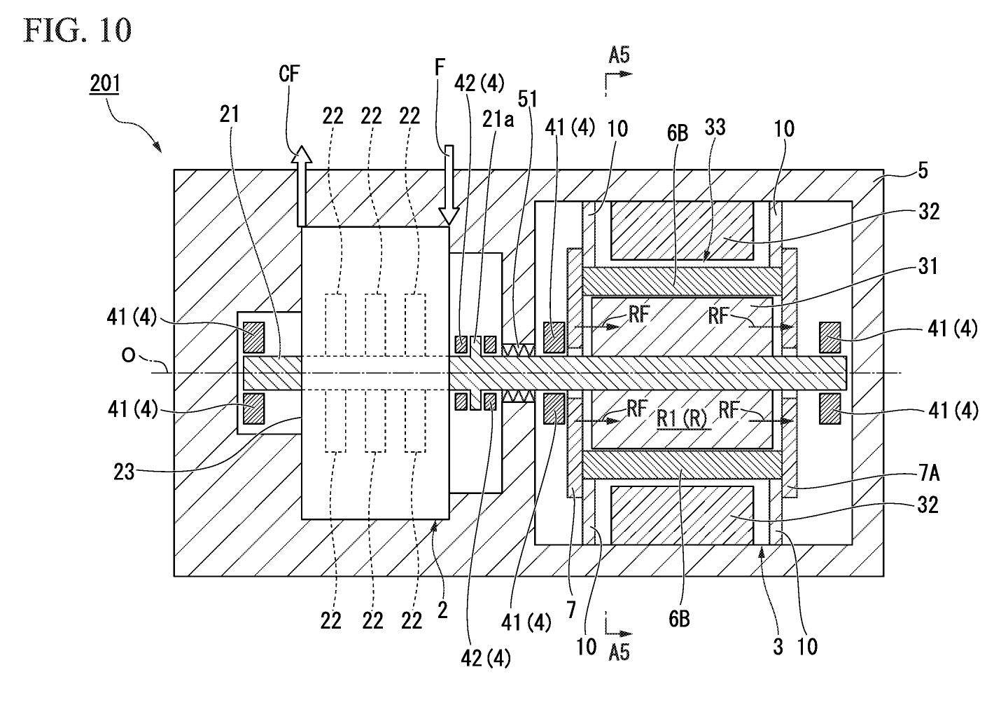

Hereinafter, a fifth embodiment of the present invention will be described with reference to FIG. 10.

A partitioning member 6B is disposed in an annular gap 33 between the rotor 31 and the stator 32, and is provided in a state in which it does not come into contact with the rotor 31 and the stator 32. Specifically, the partitioning member 6B is fixed to the casing 5 to be relatively non-rotatable with respect to the stator 32. For example, the support member 10 is provided on the casing 5 to protrude radially inward at both sides of the stator 32 in the direction of the axis O, and the partitioning member 6B is fixed to the support member 10. The support member 10 may have an annular shape with the axis O as the center or may have a columnar shape protruding inward in the radial direction at a part in the circumferential direction, and its shape is not limited.

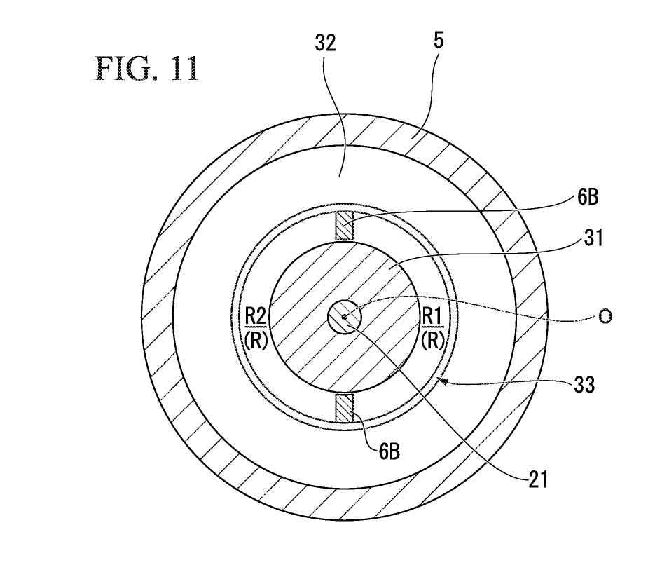

More specifically, as illustrated in FIG. 11, the partitioning member 6B extends to protrude radially inward from the support member 10 to partition the gap 33 into a plurality of spaces R in the circumferential direction, and has a flat plate shape which extends in the gap 33 over the entire region in the direction of the axis O. Further, in the present embodiment, the partitioning members 6B are provided at two positions separated by 180 degrees in the circumferential direction. As a result, the gap 33 is partitioned into two spaces R1 and R2.

Various materials such as metals, ceramics, and organic materials such as resins can be used for the partitioning member 6B.

Here, in the gap 33 between the rotor 31 and the stator 32, the cooling fluid RF can flow in the direction of the axis O. As the cooling fluid RF, for example, a leaked flow in which a part of the compressed fluid CF from the compressor 2 has leaked from the seal member 51, a cooling medium introduced from the outside of the casing 5, or bleed air from the compressor 2 can be used.

The fluid introduction section 7 allows the cooling fluid RF to flow in from the different sides in the direction of the axis O for the space R1 and the space R2. That is, the cooling fluid RF flows into the space R1 from the compressor 2 side, which is one side in the direction of the axis O, and the cooling fluid RF flows into the space R2 from the other side in the direction of the axis O.

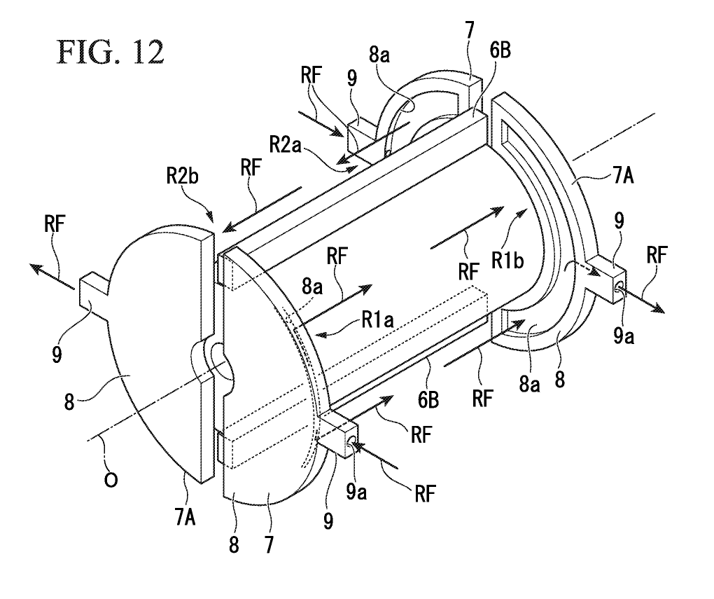

More specifically, as illustrated in FIG. 12, the fluid introduction section 7 is, for example, a manifold provided integrally with the support member 10. That is, the fluid introduction section 7 has a semicircular curved flow passage section 8 which covers an opening (inflow port R1a) on one side of the space R1 in the direction of the axis O, and a protruding flow passage section 9 which protrudes outward in the radial direction from the intermediate position (dead center in the circumferential direction) of the curved flow passage section 8.

The curved flow passage section 8 is formed with a curved flow passage 8a which opens over substantially the entire circumferential direction of the surface facing the inflow port R1a.

A protruding flow passage 9a is formed in the protruding flow passage section 9 to communicate with the curved flow passage section 8 and opens radially outward.

The cooling fluid RF is introduced into the protruding flow passage 9a so that the cooling fluid RF can flow into the space R1 from the inflow port R1a through the curved flow passage 8a.

Here, in the present embodiment, on the other side of the partitioning member 6B in the direction of the axis O, a fluid outflow section 7A having the same shape as the fluid introduction section 7 which has a curved flow passage section 8 which covers an opening (outflow port R1b) on the other side of the space R1 in the direction of the axis O, and a protruding flow passage section 9 which protrudes outward in the radial direction from the intermediate position (dead center in the circumferential direction) of the curved flow passage section 8 is provided. The cooling fluid RF that has flowed through the space R1 can flow out of the protruding flow passage section 9 through the fluid outflow section 7A.

Likewise, the fluid introduction section 7 is provided to cover the inflow port R2a which is an opening on the other side of the space R2 in the direction of the axis O, and a fluid outflow section 7A is provided to cover an outflow port R2b which is an opening on one side of the space R2 in the direction of the axis O.

According to the compressor system 201 of the present embodiment described above, the cooling fluid RF flows into each of the spaces R1 and R2 formed by partitioning the gap 33 between the rotor 31 and the stator 32 in the circumferential direction by the partitioning member 6B from different sides in the direction of the axis O. Therefore, the cooling fluid RF flows through the spaces R1 and R2 in opposite directions from each other.

Here, since the cooling fluid RF flows through the gap 33 while exchanging heat with the rotor 31, the temperature of the cooling fluid RF on the downstream side in each of the spaces R1 and R2 is higher than the temperature on the upstream side. However, in the present embodiment, the flowing direction of the cooling fluid RF is in the opposite direction between the plurality of spaces R1 and R2 aligned in the circumferential direction, and the rotor 31 relatively rotates with respect to the plurality of spaces R1 and R2.

For this reason, on the downstream side of the spaces R1 and R2, the cooling fluid RF having the high temperature and the cooling fluid RF having the low temperature alternately come into contact with the outer surface of the rotor 31. Therefore, even when the cooling fluid RF reaches a high temperature on the downstream side of the spaces R1 and R2, it is possible to prevent the cooling fluid RF having the high temperature from always coming into contact with the rotor 31 at the same position. Therefore, the rotor 31 can be efficiently cooled throughout the direction of the axis O, and the motor 3 can be efficiently cooled.

### Sixth Embodiment

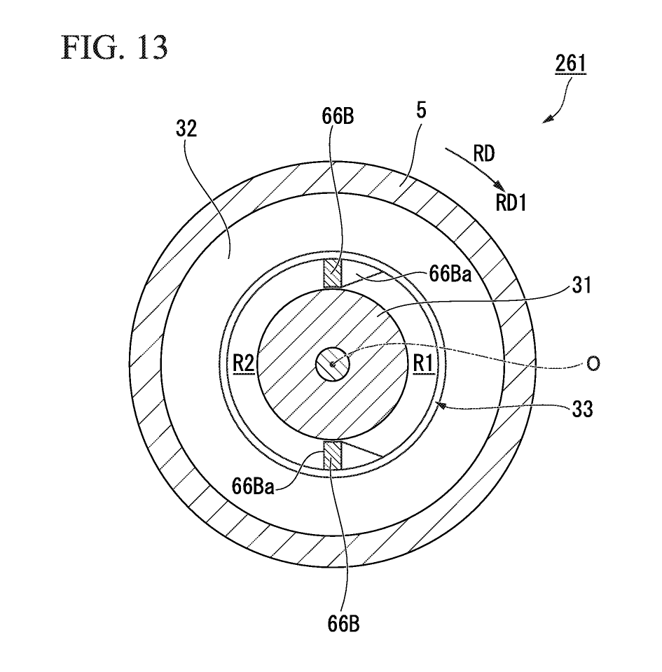

Next, a compressor system 261 of a sixth embodiment will be described with reference to FIG. 13.

In the sixth embodiment, the same constituent elements as those of the first embodiment are denoted by the same reference numerals, and a detailed description thereof will not be provided. The compressor system 261 of the sixth embodiment is different from the first embodiment in the partitioning member 66B.

As illustrated in FIG. 13, the partitioning member 66B is provided to be inclined with respect to the axis O. More specifically, the partitioning member 66B has a flat plate shape, and the end surface facing the inflow port R1a (R2a) side extends in the radial direction, and also extends toward the one side RD1 of the rotational direction RD of the rotor 31 in the circumferential direction toward the downstream side in the flowing direction of the cooling fluid RF. That is, the partitioning member 66B has a guide surface 66Ba that faces the upstream side in the flowing direction of the cooling fluid RF and inclines toward the front side RD1 in the rotational direction RD of the rotor 31 with respect to the axis O toward the downstream side.

In the compressor system 261 according to the present embodiment described above, by guiding the cooling fluid RF in the spaces R1 and R2 with the guide surface 66Ba of the partitioning member 66B, a turning component directed toward the front RD1 in the rotational direction RD toward the downstream side is imparted to the cooling fluid RF. Therefore, the cooling fluid RF can be made to flow in the flowing direction of the cooling fluid RF in the advancing direction of the outer surface of the rotating rotor 31. Therefore, it is possible to suppress the amount of heat generated by shearing caused by rapid acceleration of the cooling fluid RF due to the contact between the cooling fluid RF and the outer surface of the rotor 31, and the cooling efficiency of the rotor 31 can be improved.

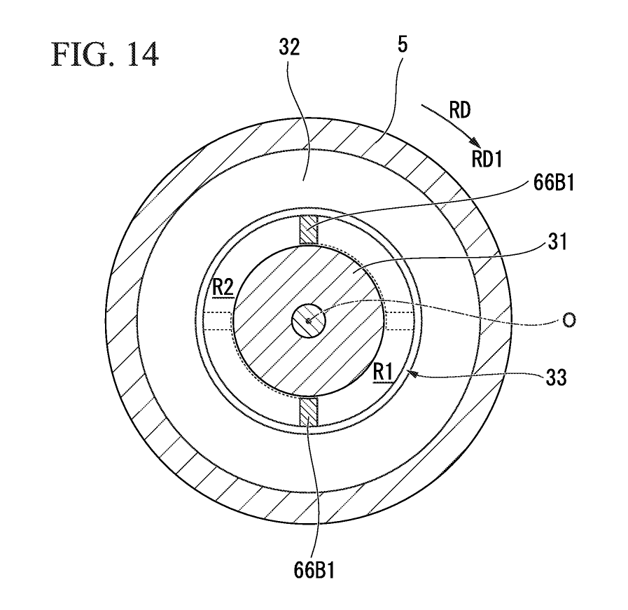

As illustrated in FIG. 14, in the compressor system 261 of the present embodiment, the partitioning member 66B1 may be, for example, a member having a spiral plate shape which extends toward the front RD1 in the rotational direction RD of the rotor 31 toward the downstream side in the flowing direction of the cooling fluid RF. Even with such a spiral member, it is possible to effectively impart a turning component, which is directed to the front RD1 in the rotational direction RD toward the downstream side, to the cooling fluid RF. Further, it is possible to suppress the amount of heat generated by shearing caused when the cooling fluid RF is rapidly accelerated, and the cooling efficiency of the rotor 31 can be improved.

Although the fifth embodiment and the sixth embodiment of the present invention have been described in detail with reference to the drawings, the respective configurations and combinations thereof in the respective embodiments are merely examples, and additions, omissions, substitutions, and other changes to the configuration can be made within the scope that does not depart from the gist of the present invention. Further, the present invention is not limited by the embodiments, and is limited only by the claims.

For example, the partitioning members 6B, 66B, and 66B1 may be disposed at least in a region in which the rotor 31 and the stator 32 face in the radial direction. Further, the partitioning members 6B, 66B, and 66B1 may be directly fixed to the stator 32.

Further, by using a metal material having high thermal conductivity for the partitioning members 6B, 66B, and 66B1, heat exchange between the space R1 and the space R2 may be promoted and the cooling of the rotor 31 may be made uniform.

Further, the number of the partitioning members 6B, 66B, and 66B1 is not limited to the above-described case, and at least two or more of them may be provided. Further, they may be provided at irregular intervals in the circumferential direction. When three or more partitioning members 6B, 66B, and 66B1 are provided, the flowing direction of the cooling fluid RF may be different between the spaces R adjacent to each other in the circumferential direction, but the present invention is not limited thereto. That is, the flowing direction of the cooling fluid RF may be different in at least two spaces.

Further, for example, by increasing the wall thickness of the partitioning member 6 B (66B and 66B1) toward the downstream side, it is possible to reduce the cross-sectional area of the flow passage in the cross-section orthogonal to the axis O of the spaces R1 and R2 from the upstream side to the downstream side. In this case, since the flow rate of the cooling fluid RF can be increased on the downstream side, heat transfer between the cooling fluid RF and the rotor 31 can be promoted even by the cooling fluid RF having the higher temperature by performing the heat exchange, and it is possible to effectively perform heat exchange with the rotor 31.

### Seventh Embodiment

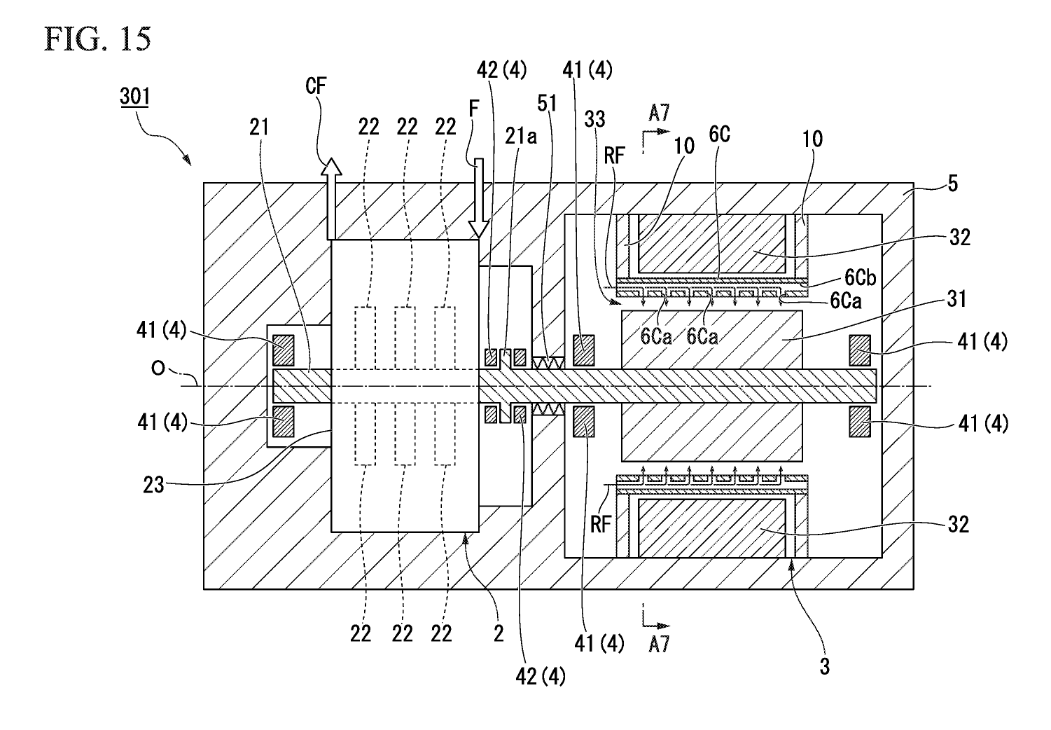

Hereinafter, a seventh embodiment of the present invention will be described with reference to FIG. 15.

A compressor system 301 includes a fluid supply member 6C disposed on the outer circumferential side of the rotor 31, instead of the partitioning member 6 (6A, 66A, 6B, 66B, and 66B1).

The fluid supply member 6C is disposed in an annular gap 33 between the rotor 31 and the stator 32, and is provided in a state in which it does not come into contact with the rotor 31 and the stator 32. Specifically, the fluid supply member 6C has a cylindrical shape with the axis O as the center.

Various materials such as metals, ceramics, and organic materials such as resins can be used for the fluid supply member 6C.

The fluid supply member 6C is fixed to the casing 5 so as not to be rotatable with respect to the stator 32. For example, in the casing 5, the support members 10 are provided at both end surfaces directed in the direction of the axis O of the stator 32 to protrude radially inward to face in the direction of the axis O, and the fluid supply member 6C is fixed to the support member 10.

The support member 10 may have an annular shape with the axis O as the center or may have a column shape protruding radially inward at a part in the circumferential direction, and its shape is not limited.

Further, in the fluid supply member 6C, a plurality of ejection ports 6Ca which open toward the rotor 31 and can eject the cooling fluid RF are formed at intervals in the direction of the axis O.

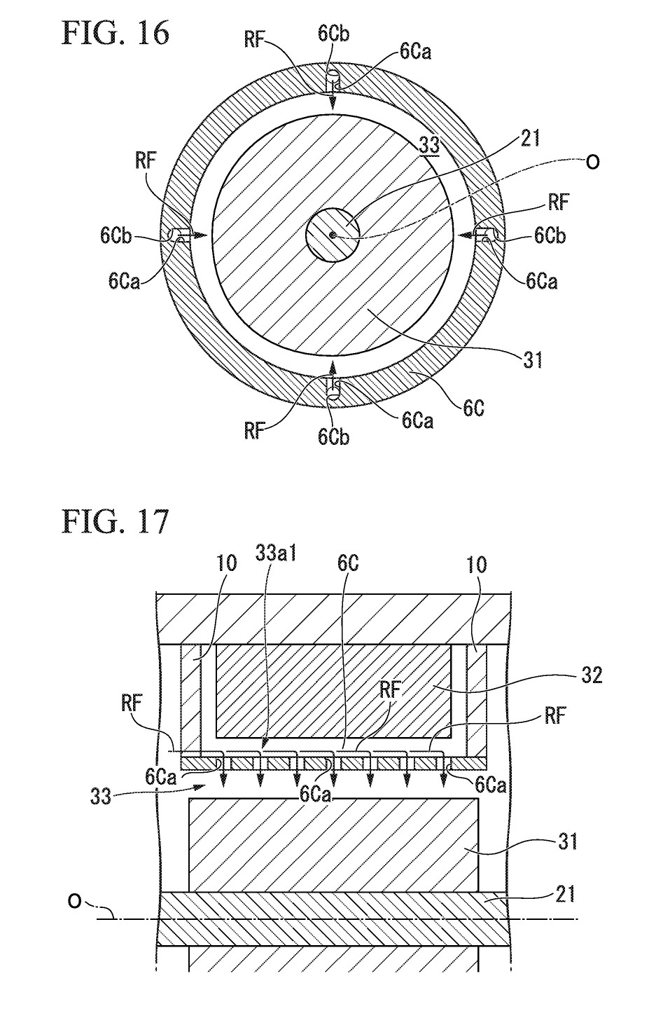

Further, as illustrated in FIG. 16, a plurality of ejection ports 6Ca are formed at intervals in the circumferential direction. In the present embodiment, the ejection port 6Ca is capable of ejecting the cooling fluid RF straight in the radial direction toward the inner side in the radial direction.

Further, when the fluid supply member 6C is viewed from the radially inner side, the ejection ports 6Ca may be disposed in a staggered pattern or may be disposed in a lattice pattern.

The fluid supply member 6C communicates with a plurality of ejection ports 6Ca aligned in the direction of the axis O so that the cooling fluid RF from the outside can flow along the axis O, and a communication hole 6Cb extending in the direction of the axis O is further formed. The cooling fluid RF is supplied to the communication hole 6Cb by, for example, a fluid supply flow passage (not illustrated) provided in the casing 5, and the cooling fluid RF is further supplied to the ejection port 6Ca via the communication hole 6Cb.

As the cooling fluid RF, it is possible to use various fluids such as a leaked flow that is a part of the compressed fluid CF leaked from the seal member 51 to the motor 3 side, a cooling medium introduced from the outside, and bleed air from the compressor 2. In the present embodiment, the cooling fluid RF flows into the communication hole 6Cb from the compressor 2 side, which is one side in the direction of the axis O.

According to the compressor system 301 of the present embodiment described above, by separately providing the fluid supply member 6C having the ejection port 6Ca formed thereon, the low-temperature cooling fluid RF can always be supplied to the ejection port 6Ca through the communication hole 6Cb before the heat exchange with the rotor 31 from the outside of the casing 5. Therefore, it is possible to always eject the low-temperature cooling fluid RF to the rotor from the ejection port 6Ca. As a result, the cooling efficiency of the rotor 31 can be improved, and the motor can be efficiently cooled.

Furthermore, by supplying the cooling fluid RF to the plurality of ejection ports 6Ca aligned in the direction of the axis O through the communication hole 6Cb, it is possible to evenly eject the cooling fluid RF over the direction of the axis O with respect to the outer surface of the rotor 31. Therefore, the cooling efficiency of the rotor 31 can be further improved.

Here, in the present embodiment, as illustrated in FIG. 17, the communication hole 6Cb is not formed in the fluid supply member 6C, and the ejection port 6Ca may be formed so that the ejection port 6Ca passes through the fluid supply member 6C in the radial direction. In this case, by supplying the cooling fluid RF to the gap 33a1 formed between the stator 32 and the fluid supply member 6C, the cooling fluid RF can be ejected from the ejection port 6Ca toward the rotor 31.

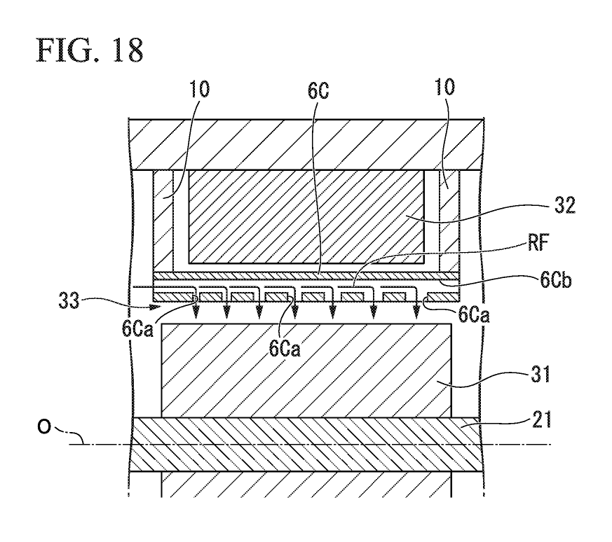

Further, in the present embodiment, as illustrated in FIG. 18, the ejection port 6Ca located on the downstream side (the other side in the direction of the axis O) in the flowing direction of the cooling fluid RF flowing through the communication hole 6Cb has an opening diameter larger than that of the ejection port 6Ca located on the upstream side thereof.

Here, when the cooling fluid RF flows through the communication hole 6Cb, the pressure loss increases toward the downstream side in the flowing direction. Since the opening diameter of the ejection port 6Ca on the downstream side is larger, it is possible to eject the cooling fluid RF of a sufficient flow rate toward the rotor 31 even on the downstream side irrespective of such pressure loss. Therefore, the cooling efficiency of the rotor 31 can be further improved.

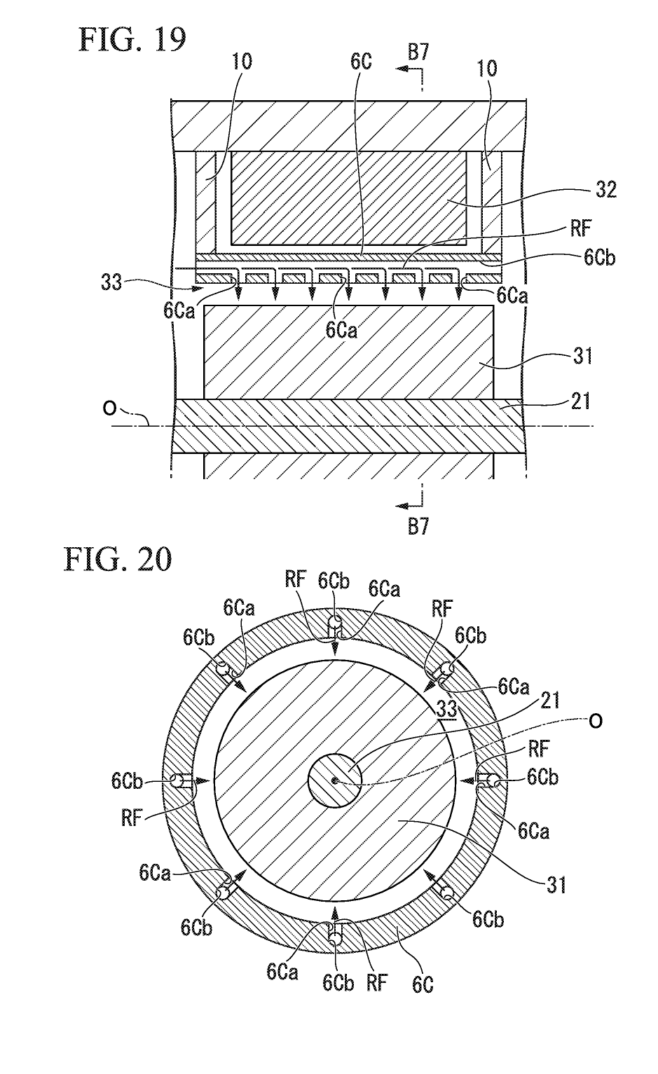

Further, in the present embodiment, as illustrated in FIGS. 19 and 20, more of the ejection ports 6Ca (FIG. 20) located on the downstream side in the flowing direction of the cooling fluid RF flowing through the communication hole 6Cb may be formed in the circumferential direction than the ejection ports 6Ca (see FIG. 16) located on the upstream side. That is, the formation interval (pitch) in the circumferential direction may be narrower in the ejection port 6Ca located on the downstream side than the ejection port 6Ca of the upstream side.

By reducing the formation pitch of the ejection ports 6Ca on the downstream side in this way, it is possible to eject the cooling fluid RF of a sufficient flow rate toward the rotor 31 even on the downstream side on which the pressure loss increases. Therefore, the cooling efficiency of the rotor 31 can be further improved.

### Eighth Embodiment

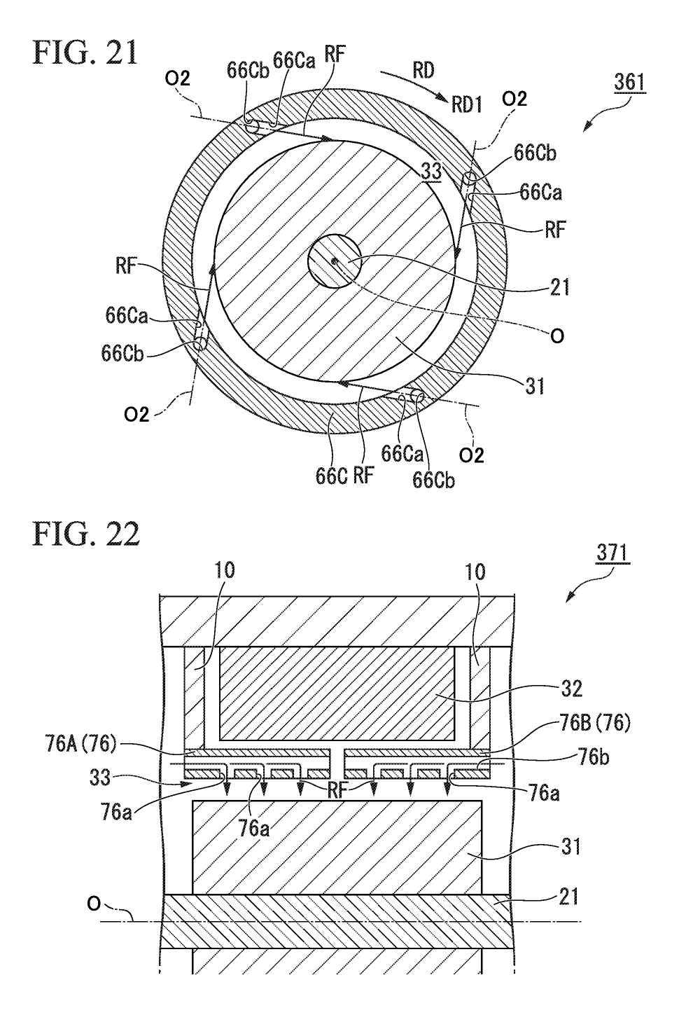

Next, a compressor system 361 of an eighth embodiment will be described with reference to FIG. 21.

In the eighth embodiment, the same constituent elements as those in the seventh embodiment are denoted by the same reference numerals, and a detailed description thereof will not be provided. The compressor system 361 of the eighth embodiment is different from the seventh embodiment in the fluid supply member 66C.

The plurality of ejection ports 66Ca in the fluid supply member 66C communicate with the communication holes 66Cb and are formed to be able to eject the cooling fluid RF toward the front RD1 side in the rotational direction RD of the rotor 31. In other words, the ejection port 66Ca is formed so that an extension line of the center axis O2 of the ejection port 66Ca passes through the rotor 31.

Since the rotor 31 rotates in the rotational direction RD, by ejecting the cooling fluid RF ejected from the ejection port 66Ca toward the front RD1 in the rotational direction RD, it is possible to allow the flowing direction of the cooling fluid RF to follow the advancing direction of the outer surface of the rotating rotor 31. As a result, it is possible to suppress the amount of heat generated by shearing caused by rapid acceleration of the cooling fluid RF due to the contact between the cooling fluid RF with the outer surface of the rotor 31. Therefore, the cooling efficiency of the rotor 31 can be further improved.

### Ninth Embodiment

Next, a compressor system 371 of the ninth embodiment will be described with reference to FIG. 22.

In the ninth embodiment, the same constituent elements as those in the seventh embodiment and the eighth embodiment are denoted by the same reference numerals, and a detailed description thereof will not be provided. In the compressor system 371 of the ninth embodiment, the fluid supply member 76 is different from those of the seventh embodiment and the eighth embodiment.

The fluid supply member 76 is provided by being divided into two parts in the direction of the axis O. That is, in the compressor system 371, a first fluid supply member 76A is provided on one side in the direction of the axis O, and a second fluid supply member 76B is provided on the other side in the direction of the axis O.

The first fluid supply member 76A and the second fluid supply member 76B both have a cylindrical shape with the axis O as the center. The first fluid supply member 76A and the second fluid supply member 76B are both provided at a gap in the direction of the axis O and fixed to the casing 5 by the support member 10.

In the first fluid supply member 76A, the cooling fluid RF is supplied to the communication hole 76b from one side in the direction of the axis O. In the second fluid supply member 76B, the cooling fluid RF is supplied to the communication hole 76b from the other side in the direction of the axis O. Further, the cooling fluid RF is ejected from the ejection port 76a toward the rotor 31.

In the compressor system 371 of the present embodiment described above, it is possible to always supply the lower temperature cooling fluid RF to the communication hole 76b before performing heat exchange with the rotor 31, and it is possible to always eject the cooling fluid RF from the ejection port 76a. Accordingly, the cooling efficiency of the rotor 31 can be improved. As a result, the motor can be efficiently cooled.

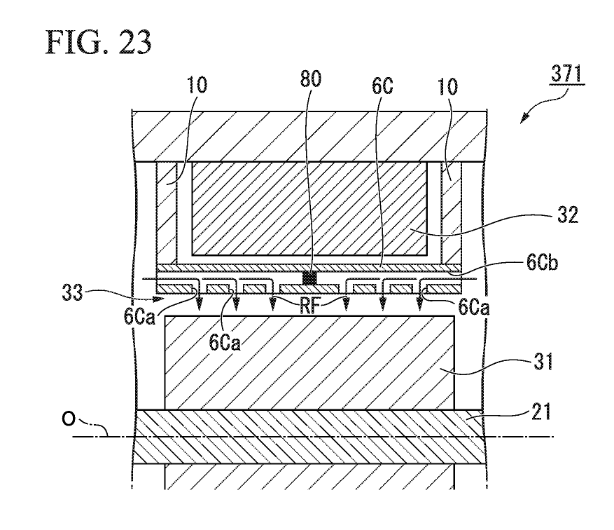

In this embodiment, as illustrated in FIG. 23, at the intermediate position (for example, the center position of the fluid supply member 6C in the direction of the axis O) of the communication hole 6Cb of one fluid supply member 6C similar to the seventh embodiment, a stopper 80 for blocking the communication hole 6Cb may be provided, and the cooling fluid RF may be supplied to the communication hole 6Cb from both sides in the direction of the axis O. Also in this case, it is possible to always supply the lower temperature cooling fluid RF to the ejection port 6Ca before heat exchange with the rotor 31, to eject the cooling fluid RF from the ejection port 6Ca, and to improve the cooling efficiency of the rotor 31. As a result, the motor can be efficiently cooled.

Although the seventh to ninth embodiments of the present invention have been described in detail with reference to the drawings, the respective configurations and combinations thereof in the respective embodiments are merely examples, and additions, omissions, substitutions, and other changes to the configuration can be made within the scope that does not depart from the gist of the present invention. Further, the present invention is not limited by the embodiments, and is limited only by the claims.

For example, the number of communication holes 6Ca (66Ca and 76a) is not particularly limited, and only one may be formed.

Further, since the amount of heat generated at the position at which the rotor 31 and the stator 32 face each other in the radial direction increases, the ejection ports 6Ca (66Ca and 76a) may be formed at least in the facing regions in which the rotor 31 and the stator 32 face in the radial direction.

The shape of the fluid supply member 6C (66C and 76) is not limited to the above-described case either. For example, the fluid supply member may be a flat plate-like member disposed in the gap 33.

Also, the support member 10 is not limited to the above case. That is, the fluid supply member 6C (66C, 76) may be held in the gap 33 between the rotor 31 and the stator 32. For example, the fluid supply member 6C (66C and 76) may be directly fixed to the stator 32.

Further, each of the seventh embodiment to the ninth embodiment described above and each modified example can be appropriately combined.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### INDUSTRIAL APPLICABILITY

According to the above compressor system, it is possible to efficiently cool the motor.

### REFERENCE SIGNS LIST

1 Compressor system
2 Compressor
3 Motor
4 Bearing unit
5 Casing
6 Partitioning member
6a Inner surface
6b Outer surface
10 Support member
21 Shaft
22 Impeller
23 Housing
31 Rotor
32 Stator
33 Gap
41 Journal bearing
42 Thrust bearing
51 Seal member
F Fluid
CF Compressed fluid
LF Leaked flow
C1 Rotor-side flow passage
C2 Stator-side flow passage
O Axis
61 Compressor system
66 Partitioning member
66a Inner surface
66b Outer surface
101, 161 Compressor system
6A Partitioning member (turn imparting portion)
6Aa Inner surface (front surface)
6Ab Recess
33a Gap
RF Cooling fluid
RD Rotational direction
RD1 Front
W Width
66A Guide member (turn imparting portion)
IN Inflow port
66Aa Guide surface
66Ab Rear surface
66Ac Leading edge
66Ad Trailing edge
S1, S2 Gap
201, 261 Compressor system
6B, 66B, 66B1 Partitioning member
7 Fluid introduction section
7A Fluid outlet section
8 Curved flow passage section
8a Curved flow passage
9 Protruding flow passage section
9a Protruding flow passage
66Ba Guide surface
CF Compressed fluid
R, R1, R2 Space
R1a, R2a Inflow port
R1b, R2b Outflow port
301 Compressor system
6C Fluid supply member
6Ca Ejection port
6Cb Communication hole
33a1 Gap
361 Compressor system
66C Fluid supply member
66Ca Ejection port
66Cb Ejection port
O2 Center axis
371 Compressor system
76 Fluid supply member
76a Ejection port
76b Communication hole
76A First fluid supply member
76B Second fluid supply member
80 Stopper

1. A compressor system comprising:
a motor comprising:
a rotor that rotates around an axis; and
a stator disposed on an outer circumferential side of the rotor with a gap from the rotor;
a compressor that rotates together with the rotor to generate a compressed fluid; and
a partitioning member that is disposed in the gap formed between the rotor and the stator to partition the gap in the radial direction, and forms a rotor-side flow passage through which a cooling fluid can flow along the axis with the rotor, and a stator-side flow passage through which the cooling fluid can flow along the axis with the stator,
wherein the partitioning member has a cylindrical shape with the axis as a center and has a shape in which a thickness dimension in a radial direction of the rotor increases from one side to the other side of the axis.

2. The compressor system according to claim 1, wherein the cooling fluid flowing through the rotor-side flow passage and the stator-side flow passage is a leaked flow of the compressed fluid from the compressor.

3. The compressor system according to claim 1, wherein the partitioning member has a shape in which an inner diameter dimension decreases from one side to the other side of the axis, and
the cooling fluid flows into the rotor-side flow passage from one side of the axis.

4. The compressor system according to claim 1, wherein the partitioning member has a shape in which an outer diameter dimension decreases from one side to the other side of the axis, and
the cooling fluid flows into the stator-side flow passage from the other side of the axis.

5. The compressor system according to claim 1, wherein the cooling fluid flows into the rotor-side flow passage and the stator-side flow passage from one side of the axis.

6. The compressor system according to claim 1, wherein the partitioning member is provided at least in a region in which the rotor and the stator face in the radial direction of the rotor.

7. A compressor system comprising:
a motor comprising:
a rotor that rotates around an axis and
a stator disposed on an outer circumferential side of the rotor with a gap allowing the cooling fluid to flow along the axis from the rotor;
a compressor that rotates together with the rotor to generate a compressed fluid; and
a guide member that is disposed on an upstream side in the flowing direction from the inflow port of the cooling fluid in the gap between the rotor and the stator, and is provided to be relatively non-rotatable with respect to the stator,
wherein the guide member has a first guide surface that faces the upstream side in the flowing direction of the cooling fluid and is curved and inclined forward in the rotational direction of the rotor with respect to the axis toward the downstream side, and a second guide surface that faces the downstream side in the flowing direction of the cooling fluid and is curved and inclined forward in the rotational direction of the rotor with respect to the axis toward the downstream side.

8. (canceled)

9. (canceled)

10. (canceled)

11. (canceled)

12. A compressor system comprising:
a motor comprising:
a rotor that rotates around an axis; and
a stator disposed on an outer circumferential side with a gap that allows a cooling fluid to flow along the axis side, from the rotor;
a compressor that rotates together with the rotor to generate a compressed fluid;
a plurality of partitioning members that are provided to be relatively non-rotatable with respect to the stator and to extend from the stator toward the rotor, and partition the gap formed between the stator and the rotor into a plurality of spaces in a circumferential direction; and
a fluid introduction section that allows the cooling fluid to flow in at least two spaces among the plurality of spaces from different sides in the direction of the axis.

13. The compressor system according to claim 12, wherein the partitioning member has a plate shape, and has a guide surface that faces the upstream side in the flowing direction of the cooling fluid and is inclined forward in the rotational direction of the rotor with respect to the axis, toward the downstream side.

14. The compressor system according to claim 13, wherein the partitioning member is a member having a spiral plate shape that extends forward in the rotational direction of the rotor, toward the downstream side in the flowing direction of the cooling fluid, and
the guide surface is a surface that faces the upstream side in the flowing direction of the cooling fluid in the member having the spiral plate shape.

15. The compressor system according to claim 12, wherein the partitioning member is provided at least in a region in which the rotor and the stator face in the radial direction of the rotor.

16. A compressor system comprising:
a motor comprising:
a rotor that rotates around an axis; and
a stator disposed on an outer circumferential side of the rotor with a gap from the rotor;
a compressor that rotates together with the rotor to generate a compressed fluid; and
a fluid supply member that is disposed in the gap formed between the rotor and the stator, is provided to be relatively non-rotatable with respect to the stator, extends in a direction of the axis of rotation of the rotor, and comprises a communication hole that extends in the direction of the axis to allow cooling fluid from the outside to flow in from one side of the axis, and a plurality of ejection ports that communicate with the communication hole and opens toward the rotor to allow the cooling fluid to be ejected.

17. The compressor system according to claim 16, wherein the ejection port of the fluid supply member is formed so that the cooling fluid can be ejected toward the front side in the rotational direction of the rotor.

18. (canceled)

19. The compressor system according to claim 16, wherein, in the fluid supply member, the ejection port located on the downstream side in the flowing direction of the cooling fluid flowing through the communication hole has an opening diameter larger than that of the ejection port located on the upstream side.

20. The compressor system according to claim 16, wherein the plurality of the ejection ports of the fluid supply member are formed at intervals in the direction of the axis and the circumferential direction of the rotor, and
in the fluid supply member, more of the ejection ports located on the downstream side in the flowing direction of the cooling fluid flowing through the communication hole are formed in the circumferential direction than the ejection ports located on the upstream side.
